(19) United States
(12) Patent Application Publication
(10) Pub. No.: US 2024/0380519 A1
(43) Pub. Date: Nov. 14, 2024

(54) WIRELESS LOCAL AREA NETWORK (WLAN) LINK ADAPTATION FOR MULTI-USER TRANSMISSION

(71) Applicant: APPLE INC., Cupertino, CA (US)

(72) Inventors: Wook Bong LEE, San Jose, CA (US); Tianyu WU, Monterey, CA (US); Zhou LAN, San Jose, CA (US); Feng JIANG, Sunnyvale, CA (US); Mohamed ABOUELSEOUD, Burlingame, CA (US); Chitto GHOSH, Fremont, CA (US); Anuj BATRA, Redwood City, CA (US); Yan ZHANG, Palo Alto, CA (US)

(73) Assignee: APPLE INC., Cupertino, CA (US)

(21) Appl. No.: 18/658,915

(22) Filed: May 8, 2024

Related U.S. Application Data
(63) Continuation-in-part of application No. 18/658,805, filed on May 8, 2024.
(60) Provisional application No. 63/501,375, filed on May 10, 2023.
(60) Provisional application No. 63/522,642, filed on Jun. 22, 2023.

(51) Int. Cl. H04L 1/1607; H04W 84/12

(52) U.S. Cl. CPC H04L 1/1621; H04L 1/1664; H04W 84/12

(57) ABSTRACT

Some aspects of this disclosure include an apparatus, method, and computer program product for wireless local area network (WLAN) link adaptation for multi-user transmission. For example, a receiving device can receive a multi-user-physical layer (PHY) protocol data unit (MU-PPDU) including a preamble and a plurality of data portions. The preamble can include a PHY multi-user-block acknowledgement request (MU-BAR) frame indicating a frequency band for transmitting a trigger-based (TB)-PPDU. The receiving device can decode at least a portion of a first data portion of the and transmit the TB-PPDU including feedback (FB) data corresponding to the first data portion in the frequency band. Even if the decoding of the first data portion fails, the receiving device can use information in the PHY MU-BAR frame to transmit a TB-PPDU to the transmitting device that includes a negative acknowledgment (NACK) frame and a FB sequence number of the MU-PPDU.

### CROSS-REFERENCE TO RELATED APPLICATIONS

The present application is a continuation in part of U.S. patent application Ser. No. 18/658,805, filed on May 8, 2024, and claims the benefit of U.S. Provisional Patent Appl. No. 63/501,375, filed on May 10, 2023 and U.S. Provisional Patent Appl. No. 63/522,642, filed on Jun. 22, 2023, all of which are incorporated herein by reference in their entireties.

### BACKGROUND

### Field

The described aspects relate generally to a wireless local area network (WLAN) link adaptation system.

### Related Art

WLAN link adaptation enables more efficient communication by setting the appropriate transmission parameters for the transmitting device to transmit data to the receiving device, depending on the conditions of the frequency band used for communication.

### SUMMARY

Some aspects of this disclosure include a system, apparatus, article of manufacture, method, and/or computer program product and/or combinations and sub-combinations thereof, for wireless local area network (WLAN) link adaptations for multi-user transmissions.

In some aspects, a receiving device can receive a multi-user-physical layer (PHY) protocol data unit (MU-PPDU) including a preamble and a plurality of data portions. A first data portion of the plurality of data portions can be directed to the receiving device. The preamble can include a PHY multi-user-block acknowledgement request (MU-BAR) frame indicating a frequency band the receiving device uses for transmitting a trigger-based (TB)-PPDU. The receiving device can begin decode at least a portion of the first data portion and transmit the TB-PPDU including feedback (FB) data corresponding to the first data portion in the indicated frequency band indicated.

In some aspects, when the decoding of the first data portion fails, the TB-PPDU can include a negative acknowledgment (NACK) frame and an FB sequence number associated with the MU-PPDU. In some examples, the receiving device can decode a Media Access Control (MAC) Protocol Data Unit (MPDU) of the first data portion to decode at least a portion of the first data portion. The TB-PPDU further include a block acknowledgment (BA) frame corresponding to the decoded MPDU. In some aspects, the first data portion may not include an MU-BAR frame.

In some aspects, the receiving device can determine that the PHY MU-BAR frame is included in the preamble based at least on a value of a NACK indicator in the preamble and a number of user information fields in the preamble being greater than one. In some examples, the receiving device can determine that the PHY MU-BAR frame is included in the preamble based at least on a value of a NACK indicator in the preamble and a value of a specific bit status in the preamble.

In some aspects, the PHY MU-BAR frame can be included in a user-specific field of the preamble. The PHY MU-BAR frame can include: information common to the receiving device and a second receiving device where a second data portion of the plurality of data portions corresponds to the second receiving device; first user information corresponding to the receiving device; and second user information corresponding to the second receiving device. In some examples, the first data portion can include a trigger frame and the first user information can include a subset of the trigger frame. The first user information can include an uplink (UL) target receive power.

In some aspects, a transmitting device can transmit an MU-PPDU including a preamble and a plurality of data portions. A first data portion of the plurality of data portions can be addressed to a receiving device. The preamble can include a PHY MU-BAR frame indicating a frequency band that the receiving device uses for transmitting a TB-PPDU. The transmitting device can receive, in the indicated frequency band, the TB-PPDU including a FB data corresponding to the first data portion of the plurality of data portions. The transmitting device can configure, based at least on the FB data, a transmission parameter for a next data portion associated with the receiving device.

In some aspects, a value of a NACK indicator in the preamble and a number of user information fields in the preamble being greater than one can indicate that the PHY MU-BAR frame is included in the preamble. In some aspects, a value of a NACK indicator of the preamble and a value of a specific bit status in the preamble indicates that the PHY MU-BAR frame is included in the preamble.

In some aspects, the PHY MU-BAR frame can be included in a user-specific field of the preamble. The PHY MU-BAR frame can include: information common to the receiving device and a second receiving device where a second data portion of the plurality of data portions can correspond to the second receiving device; first user information corresponding to the receiving device; and second user information corresponding to the second receiving device.

In some aspects, the first data portion can include a trigger frame. The first user information can include a subset of the trigger frame, and the first user information can include an UL target receive power.

In some aspects, the transmitting device can determine, based at least on a communication history with the receiving device, to include the first user information corresponding to the receiving device. The communication history with the receiving device can indicate that the transmitting device has transmitted at least N MU-BAR trigger frames to the receiving device, where N is an integer, and a TB-PPDU corresponding to at least one of the N MU-BAR trigger frames has not been received within a given time frame.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for wireless local area network (WLAN) link adaptation, in accordance with some aspects of the disclosure.

FIG. 2 illustrates a block diagram of an example wireless device for WLAN link adaptation, according to some aspects of the disclosure.

FIGS. 3A and 3B illustrate examples of WLAN link adaptation flows including feedback (FB) data, according to some aspects of the disclosure.

FIGS. 4A and 4B illustrate examples of WLAN link adaptation flows including a block acknowledgment request (BAR) frame to request feedback (FB) data, according to some aspects of the disclosure.

FIGS. 5A and 5B illustrate other examples of WLAN link adaptation flow including a BAR frame to request FB data, according to some aspects of the disclosure.

FIG. 6 illustrates an example of variations in transmitting BAR frames, according to some aspects of the disclosure.

FIG. 7 illustrates an example of WLAN link adaptation flow when a preamble of the PPDU includes a NACK indicator, according to some aspects of the disclosure.

FIG. 8 illustrates an example of WLAN link adaptation flow when a feedback sequence number (FBSN) corresponds to the NACK indicator, according to some aspects of the disclosure.

FIG. 9 illustrates an example method for a receiving device in a WLAN link adaptation, according to some aspects of the disclosure.

FIG. 10 illustrates an example method for a transmitting device in a WLAN link adaptation, according to some aspects of the disclosure.

FIGS. 11A and 11B illustrate examples of WLAN link adaptation flows including a multi-user (MU)-PPDU, according to some aspects of the disclosure.

FIG. 12A illustrates an example of WLAN link adaptation flow including a physical layer (PHY) MU-BAR frame, according to some aspects of the disclosure.

FIG. 12B illustrates an example of WLAN link adaptation flow including a PHY MU-BAR frame triggering an immediate feedback from all receiving devices, according to some aspects of the disclosure.

FIG. 12C illustrates an example of WLAN link adaptation flow including a PHY MU-BAR frame triggering an immediate feedback from select receiving devices, according to some aspects of the disclosure.

FIG. 13 illustrates an example of ultra-high reliability (UHR)-signal field (SIG) content channel format where the PHY MU-BAR frame is present in the UHR-SIG, according to some aspects of the disclosure.

FIG. 14 illustrates an example of computer system for implementing some aspects or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects include a system, apparatus, article of manufacture, method, and/or computer program product and/or combinations and sub-combinations thereof for wireless local area network (WLAN) link adaptation. The quality of WLAN communications between a transmitting device and a receiving device depends on the environment of the WLAN communication path between the transmitting device and the receiving device. The technique of configuring WLAN communication parameters to adapt to the environment of a previous WLAN communication path to improve the quality of WLAN communication is called WLAN link adaptation.

Transmitting devices typically determine link adaptation parameters (e.g., modulation and coding scheme (MCS) value, number of spatial streams (NSS), resource units (RUs), etc.). But, the link adaptation parameters set by a transmitting device may not be accurate as performance can be highly dependent on the link adaptation algorithm of a receiving device. Further, some wireless communications (e.g., ultra-high reliability (UHR) wireless communications) can include challenges such as: in-device interference in 5 GHz or 6 GHz bands between (e.g., Bluetooth (BT), cellular, Ultra-wideband (UWB)); different interference levels for different subchannels in an aggregated physical layer protocol data unit (PPDU) (A-PPDU) and wide bandwidth operations; and more modes of operation such as joint transmission (JT), coordinated special reuse (CSR), and coordinated beamforming (CBF).

Several methods have been proposed as WLAN link adaptation schemes. In WLAN communications using compressed beamforming, for example, a receiving device reports the communication quality to a transmitting device, but the data overhead is too large for frequent reporting. There are also schemes in which a receiving device reports communication quality using separate packets (e.g., independent of commonly used frames, or included in the commonly used frames), but the contents of the separate packets does not include enough information to address the wireless communications challenges (e.g., in UHR communications) as described above.

Some aspects include fast feedback (FB) contents to improve WLAN link adaptation that can address the challenges of UHR wireless communications. Fast FB contents can include a feedback sequence number (FBSN) that identifies a reference packet and FB data corresponding to the receipt of the reference packet by the receiving device. The FB data can include link adaptation parameters corresponding to the receiving device that the transmitting device can use to adjust (e.g., adapt) subsequent transmissions to the same receiving device. Some aspects include an indicator that informs a receiving device whether to provide a Negative Acknowledgement (NACK) frame (e.g., control packets) with fast FB contents or not.

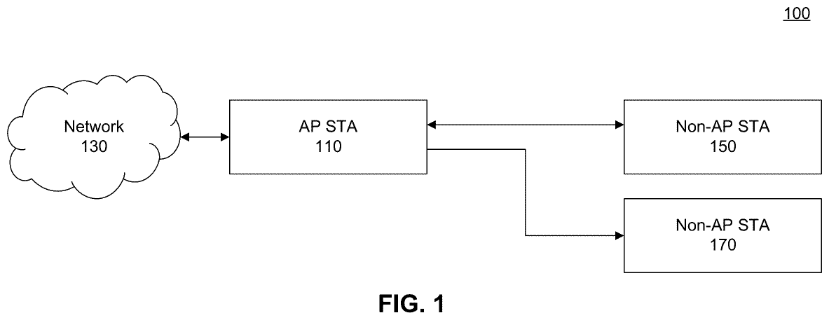

FIG. 1 illustrates an example system 100 for WLAN link adaptation, in accordance with some aspects of the disclosure. Example system 100 is provided for the purpose of illustration only and does not limit the disclosed aspects. System 100 can include, but is not limited to, an access point (AP) station (STA) 110, a non-AP STA 150, a non-AP STA 170 and a network 130. The AP STA 110 can include but is not limited to WLAN electronic devices such as a wireless router, a wearable device (e.g., a smart watch), a wireless communication device (e.g., a smart phone), or a combination thereof. The non-AP STA 150 and the non-AP STA 170 can include, but are not limited to, WLAN STAs such as wireless communication devices, smart phones, laptops, desktops, tablets, personal assistants, monitors, televisions, wearable devices, and the like. The network 130 can be the Internet and/or a WLAN. The communication between the AP STA 110 and the non-AP STA 150 can take place using wireless communications. The wireless communications can be based on a wide variety of wireless communication techniques.

The AP STA 110, and the non-AP STA 150 and/or the non-AP STA 170 can transmit and receive data via uplink communications and/or downlink communications. In WLAN communications, a device that transmits a physical layer protocol data unit (PPDU) may be referred to as the transmitting device and a device that receives the PPDU may be referred to as the receiving device. In an uplink communication, the PPDU can be transmitted from the non-AP STA 150 and/or the non-AP STA 170 to the AP STA 110. Thus, in uplink communications, the non-AP STA 150 and/or the non-AP STA 170 is a transmitting device and the AP STA 110 is a receiving device. In contrast, in a downlink communication, the PPDU is transmitted from the AP STA 110 to the non-AP STA 150 and/or the non-AP STA 170. Thus, in downlink communications, the AP STA 110 is a transmitting device and the non-AP STA 150 and/or the non-AP STA 170 is a receiving device.

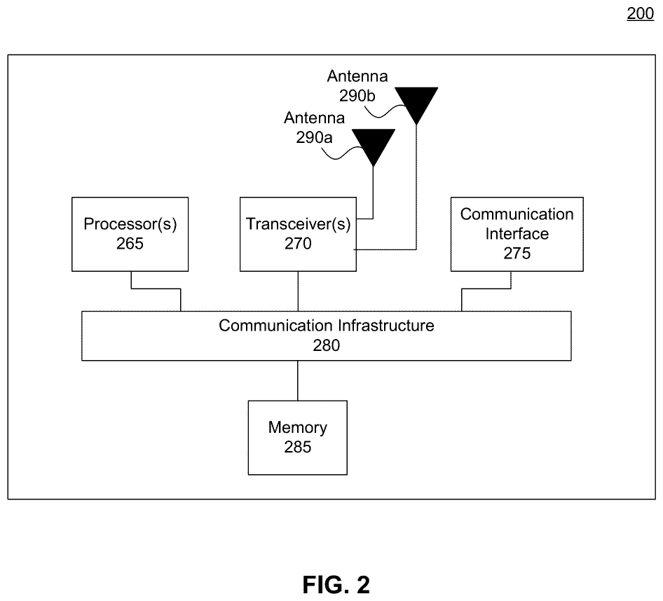

FIG. 2 illustrates a block diagram of an example wireless device 200 for WLAN link adaptation, according to some aspects of the disclosure. For explanation purposes and not a limitation, FIG. 2 can be described with reference to elements from FIG. 1. For example, wireless device 200 can be any of the electronic devices: the AP STA 110, the non-AP STA 150, or the non-AP STA 170. Wireless device 200 includes one or more processors 265, transceiver(s) 270, communication interface 275, communication infrastructure 280, memory 285, and antenna 290. Memory 285 can include random access memory (RAM) and/or cache, and can include control logic (e.g., computer instructions) and/or data. One or more processors 265 can execute the instructions stored in memory 285 to perform operations enabling wireless device 200 to transmit and receive wireless communications, including the functions for WLAN link adaptation. In some aspects, one or more processors 265 can be “hard coded” to perform the functions described herein. Transceiver(s) 270 transmits and receives wireless communications signals including wireless communications supporting WLAN link adaptation according to some aspects, and can be coupled to one or more antennas 290 (e.g., 290a, 290b). In some aspects, a transceiver 270a (not shown) can be coupled to antenna 290a and different transceiver 270b (not shown) can be coupled to antenna 290b. Communication interface 275 allows wireless device 200 to communicate with other devices that can be wired and/or wireless. Communication infrastructure 280 can be a bus. Antenna 290 can include one or more antennas that can be the same or different types.

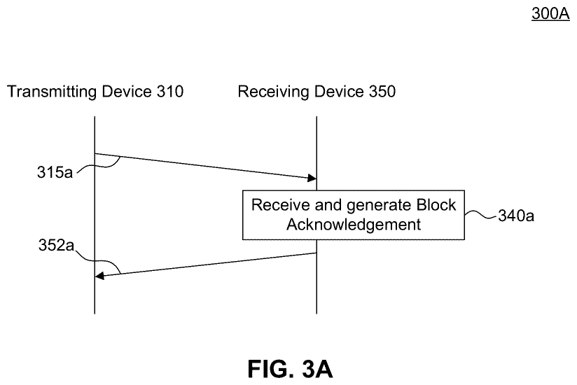

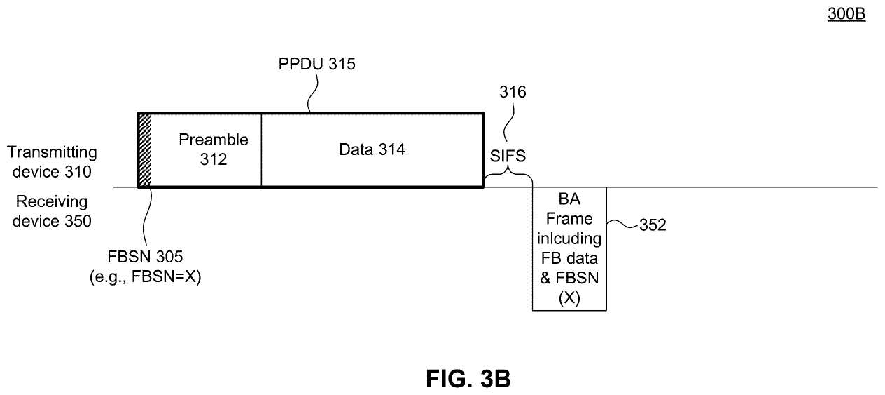

FIGS. 3A and 3B illustrate examples of WLAN link adaptation flow 300A and 300B including FB data, according to some aspects of the disclosure. For explanation purposes and not a limitation, FIGS. 3A and 3B can be described with reference to elements from FIG. 1. For example, a transmitting device 310 can be the AP STA 110, the non-AP STA 150, or the non-AP STA 170, and a receiving device 350 can be the non-AP STA 150, the non-AP STA 170, or the AP STA 110, respectively.

The WLAN link adaptation flow 300A is illustrated another way with additional details in the WLAN link adaptation flow 300B and can be described as follows:

At 315a, the transmitting device 310 can transmit a signal that can include a PPDU 315 to the receiving device 350. The PPDU 315 can include a preamble 312 and data 314. Data 314 can include a user payload and higher layer data units such as Media Access Control (MAC) Protocol Data Units (MPDUs). In some aspects, the PPDU 315 can be a multi-user (MU)-PPDU transmitted for receipt by multiple receiving devices (not shown).

At 340a, the receiving device 350 can receive and decode PPDU 315 that includes the preamble 312 and the data 314. If the receiving device 350 successfully decodes the preamble 312 and data 314, the receiving device 350 can generate a block acknowledge (BA) frame 352. The BA frame 352 can contain feedback (FB) data that includes link adaptation parameters.

At 352a, the receiving device 350 can transmit a signal to the transmitting device 310 that includes the BA frame 352. The BA frame can contain feedback (FB) data that includes link adaptation parameters. In some aspects, receiving device 350 transmits BA frame 352 after the elapse of a short inter frame space (SIFS) 316 following the receipt of the PPDU 315.

The FB data can be used by the transmitting device 310 to configure the transmission parameters for a next PPDU (not shown) to be sent to the receiving device 350. The transmission parameters can be configured according to the link adaptation parameters of the FB data. In some aspects, the FB data can contain an MCS value and/or an NSS value corresponding to the receiving device 350. For example, the receiving device 350 can determine the MCS value and/or the NSS value based on a quality of communication of the preamble 312 and/or the PPDU 315 received.

In some aspects, the FB data can include time-domain interference statistics used to determine whether to transmit a Request To Send (RTS) frame or receive a Clear To Send (CTS) frame before the next data transmission (e.g., before transmitting a next PPDU). In some aspects, the FB data can include a PPDU length(s) for the next PPDU(s) to be transmitted. The time-domain interference statistics can include but are not limited to a start time and end time of an interference.

In some aspects, the FB data can include characteristics of interference including but not limited to: the existence of interference, a type of interference, and/or whether the interference is in-channel or in an adjacent channel. In some aspects, the type of interference includes information indicating whether the interference is caused by other WLAN communication signals or other signals (e.g., BT, UWB). In some aspects, the receiving device 350 can determine the characteristics of an interference based on a quality of communication of the PPDU 315 received.

In some aspects, the transmitting device 310 can configure one or more transmission parameters for the next PPDU directed to the receiving device 350 with the link adaptation parameters based on the FB data received by the transmitting device 310. In some aspects, the transmitting device 310 can set the MCS value of a transmission parameter based on the FB data. In some aspects, the transmitting device 310 can set the NSS value of a transmission parameter based on the FB data. In some aspects, the transmitting device 310 can transmit an RTS frame and receive a CTS frame before transmitting a next PPDU, and/or the transmitting device 310 can set the length of the next PPDU based on the time-domain interference statistics of the FB data.

In some aspects, the preamble 312 can contain a feedback sequence number (FBSN) 305 corresponding to the PPDU 315. The FBSN 305 can be an integer, X, and can be included with the FB data transmitted by the receiving device 350, to indicate that the FB data corresponds to the receipt of PPDU 315. In some aspects, the FBSN 305 can be common for receiving devices allocated in the PPDU 315. For example, the FBSN 305 can be carried in a common field in a physical (PHY)-signal field (SIG). For example, the common field in the PHY-SIG can be a universal-SIG (U-SIG) and/or the common field of a SIG specific to the communication standards to which WLAN communications conform (e.g., an extremely high throughput (EHT)-SIG, and/or an ultra-high reliability (UHR)-SIG. In some aspects, the FBSN 305 can be indicated in a user-specific field in the preamble 312. In some aspects, the FBSN 305 can be included in one or more media access control (MAC) protocol data unit (MPDUs) of the data 314.

In some aspects, the BA frame 352 can contain the BA information, FBSN 305 (e.g., X) of the PPDU 315 and the FB data corresponding to the PPDU 315 received. In some aspects, if the receiving device 350 found a station (STA)-ID of receiving device 350 in a user-specific field of the preamble 312, the receiving device 350 can compute the FB data and send the FB data to a MAC layer of the receiving device 350 together with the FBSN 305 (e.g., X) as a receiver (RX)-vector (RXVECTOR). The RXVECTOR is a message from a PHY layer to a MAC layer of the receiving device 350. As such, the receiving device 350 can send the FB data with the FBSN 305 to the transmitting device 310 so that the transmitting device 310 can adjust the MCS value, the NSS value, and/or other link adaptation parameters based on the FB data.

After receiving a FBSN 305 and corresponding FB data, the transmitting device 310 can transmit the next PPDU to the corresponding receiving device (e.g., receiving device 350) using the appropriate link adaptation parameters based on the FB data. In some aspects, since the FB data is transmitted using BA frame 352 corresponding to the reception of the preamble 312 and/or data 314, the transmitting device 310 can quickly (e.g., immediately) set the appropriate link adaptation parameters for the next PPDU transmission and transmit the next PPDU to the receiving device 350. Thus, receiving the FB data is an improvement over past techniques for WLAN link adaptation.

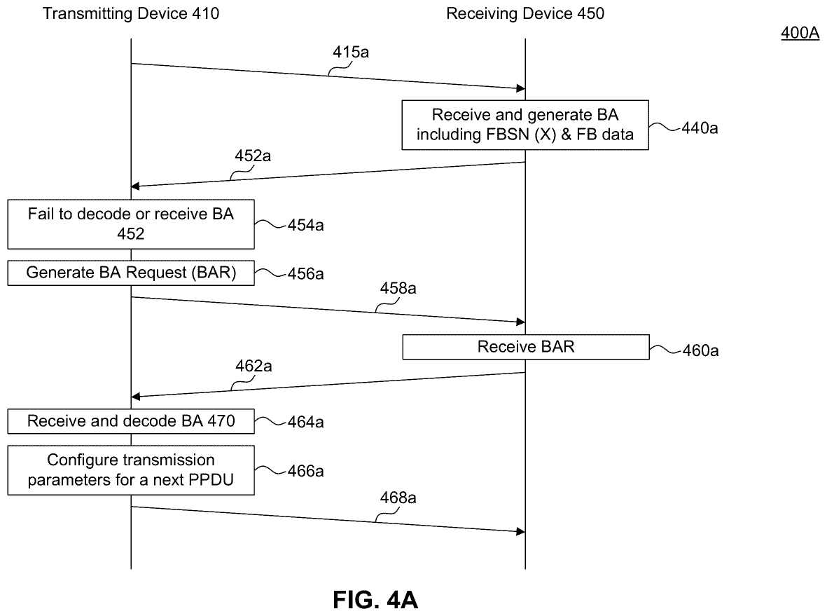

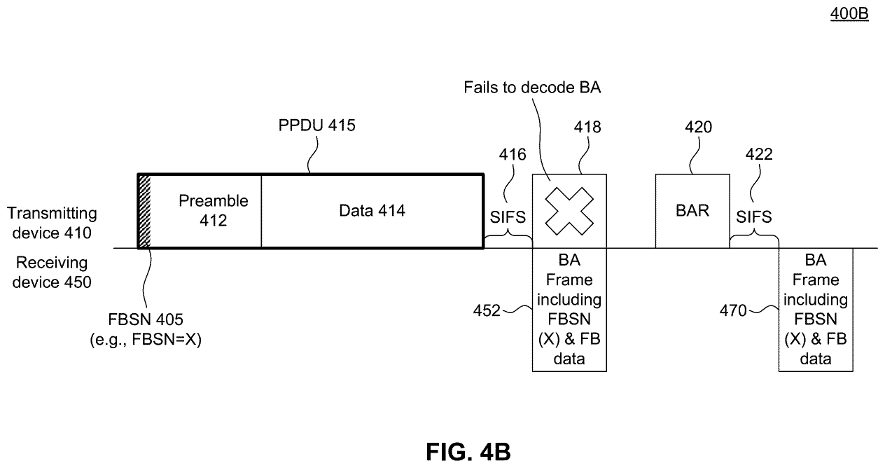

FIGS. 4A and 4B illustrate examples of WLAN link adaptation flows 400A and 400B including a block acknowledgment request (BAR) frame to request FB data, according to some aspects of the disclosure. For explanation purposes and not a limitation, FIGS. 4A and 4B can be described with reference to elements from FIG. 1. For example, a transmitting device 410 can be the AP STA 110 or the non-AP STA 150, and a receiving device 450 can be the non-AP STA 150 or the AP STA 110, respectively.

WLAN link adaptation flow 400A is illustrated another way with additional details in the WLAN link adaptation flow 400B and can be described as follows:

At 415a, the transmitting device 410 can transmit a signal that can include a PPDU 415 to the receiving device 450. The PPDU 415 can include a preamble 412 and data 414. The preamble 412 can include an FBSN 405 (e.g., X, where the X is an integer), corresponding to the PPDU 415. The properties of the FBSN are described above in the description of FIG. 3B and are not repeated here.

At 440a, the receiving device 450 receives and decodes the PPDU 415 that includes the preamble 412 and the data 414. If the receiving device 450 successfully decodes the PPDU 415, the receiving device 450 generates a BA frame 452. In some aspects, in response to the reception of the PPDU 415, receiving device 450 transmits a BA frame 452 to the transmitting device 410 immediately after a SIFS 416, the period following the PPDU 415.

At 452a, the receiving device 450 transmits the BA frame 452 to transmitting device 410. In some aspects, the BA frame 452 can contain BA information, the FBSN number X, and the FB data corresponding to the receipt of the PPDU 415 associated with the FBSN number X.

At 454a, the transmitting device 410 fails to receive BA frame 452 or fails to decode the BA frame 452, as shown at operation 418 in FIG. 4B.

At 456a, the transmitting device 410 generates a block acknowledgement request (BAR) frame.

At 458a, the transmitting device 410 transmits a block acknowledgment request (BAR) frame 420 to the receiving device 450.

At 460a, receiving device receives the BAR frame 420.

At 462a, in response to the receipt of the BAR frame 420, the receiving device 450 transmits a BA frame 470 that can include the FBSN number X, and the FB data corresponding to the receipt of PPDU 415 associated with the FBSN number X. In some aspects, the receiving device 450 transmits the BA frame 470 immediately after a SIFS 422, the period following the BAR frame 420. In some aspects, the BA frame 470 can include the latest FBSN number and FB data corresponding to the last PPDU of the PPDUs received by the receiving device 450, from the transmitting device 410 that is successfully received (e.g., decoded).

At 464a, the transmitting device 410 can receive and decode BA frame 470.

At 466a, the transmitting device 410 can configure the transmission parameter for the next PPDU directed to the receiving device 450 based on the BA information, the FBSN number X, and the FB data corresponding to the receipt of the PPDU 415 associated with the FBSN number X. Thus, the transmitting device 410 can request the FB data by using BAR frame 420 even if the BA frame 452 is not received (e.g., due to a failure to receive BA frame 452 or a failed decoding of BA frame 452 at operation 418). In some aspects, configuring the link adaptation parameters for the transmission of the next PPDU in the communication environment that caused the failure to receive BA frame 452, can increase the chances for successful receipt by receiving device 450.

At 468a, the transmitting device 410 can transmit a signal that includes the next PPDU.

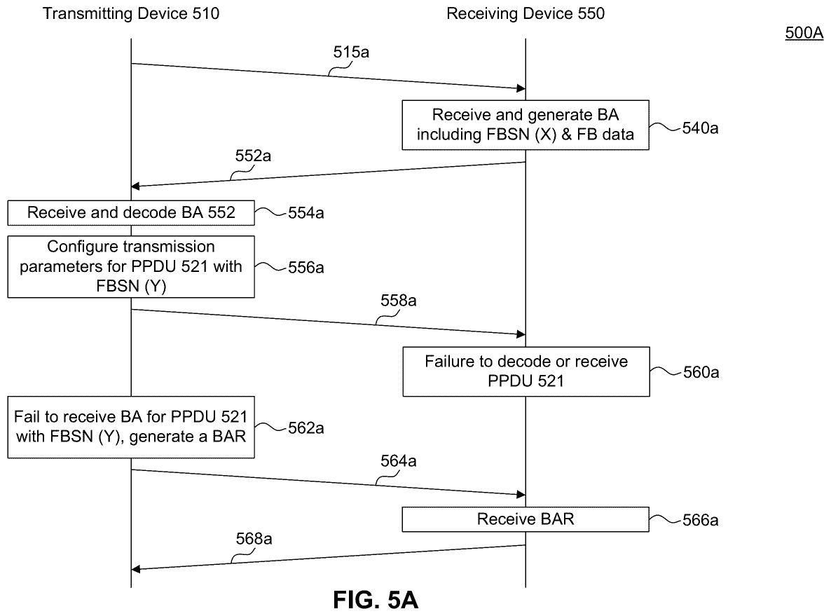

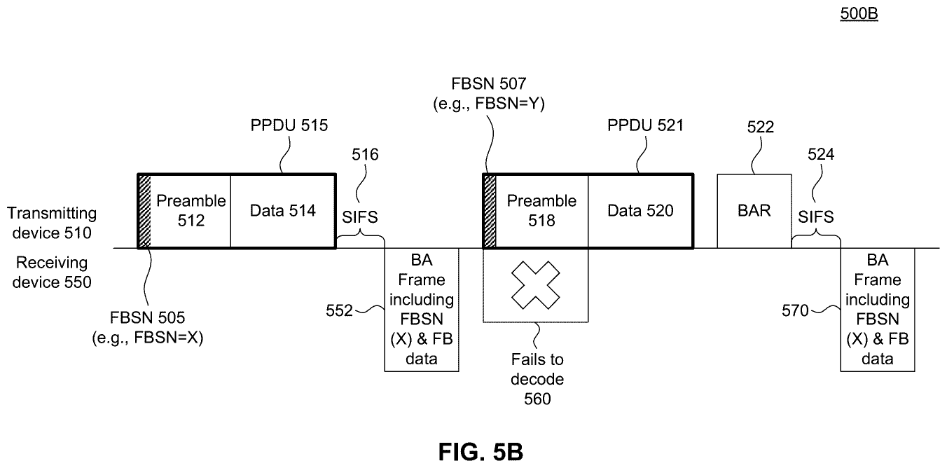

FIGS. 5A and 5B illustrate other examples of WLAN link adaptation flows 500A and 500B for including a BAR frame to request FB data, according to some aspects of the disclosure. For explanation purposes and not a limitation, FIGS. 5A and 5B can be described with reference to elements from FIG. 1. For example, a transmitting device 510 can be the AP STA 110 or the non-AP STA 150, and a receiving device 550 can be the non-AP STA 150 or the AP STA 110, respectively.

WLAN link adaptation flow 500A is illustrated another way with additional details in the WLAN link adaptation flow 500B and can be described as follows:

At 515a, the transmitting device 510 transmits a PPDU 515 with a preamble 512 and data 514 to the receiving device 550. The preamble 512 contains FBSN 505, (e.g., X, where X is an integer) corresponding to the PPDU 515.

At 540a, the receiving device 550 receives and decodes the preamble 512 and the data 514. If the receiving device 550 successfully decodes at least one of MPDUs in the PPDU 515, the receiving device 550 generates a BA frame 552.

At 552a, the receiving device transmits a BA frame 552 to the transmitting device 510. In some aspects, receiving device 550 transmits the BA frame 552 immediately after a SIFS 516, the period following the PPDU 515. In some aspects, the BA frame 552 can contain BA information, the FBSN number X, and the FB data corresponding to the receipt of the PPDU 515 associated with the FBSN number X.

At 554a, transmitting device 510 receives and decodes BA frame 552.

At 556a, the transmitting device 510 can configure the transmission parameter for the next PPDU, PPDU 521 directed to the receiving device 550 based on the FB data corresponding to FBSN X and PPDU 515.

At 558a, the transmitting device 510 transmits a PPDU 521 with a preamble 518 and data 520 to the receiving device 550. The preamble 518 contains an FBSN 507, with a number “Y” (where Y is an integer) corresponding to the PPDU 521.

At 560a, the receiving device 550 fails to receive (e.g., decode) the preamble 518, and cannot transmit a BA frame in response to transmitting device 510 as shown in operation 560 of FIG. 5B.

At 562a, the transmitting device 510 fails to receive a BA frame for PPDU 521 and generates a BAR frame 522.

At 564a, the transmitting device 510 transmits the BAR frame 522 to the receiving device 550 in response to not receiving a BA frame corresponding to the PPDU 521 from the receiving device 550. In some aspects, the transmitting device 510 can transmit BAR frame 522 in response to not receiving a BA frame after a predetermined period of time after the PPDU 521 is transmitted.

At 566a, the receiving device receives the BAR frame 522.

At 568a, the receiving device 550 transmits a BA frame 570 with an FBSN (X) and FB data corresponding to a last PPDU (e.g., PPDU 515) received from the same transmitting device (e.g., transmitting device 510). In some aspects, the receiving device 550 transmits the BA frame 570 including the FBSN (X) and FB data after a SIFS 524, the period following the BAR frame 522. Thus, the transmitting device 510 can request the FB data using BAR frame 522 when a BA frame is not received (e.g., corresponding FB data is not received because the receiving device 550 failed to decode the preamble 518).

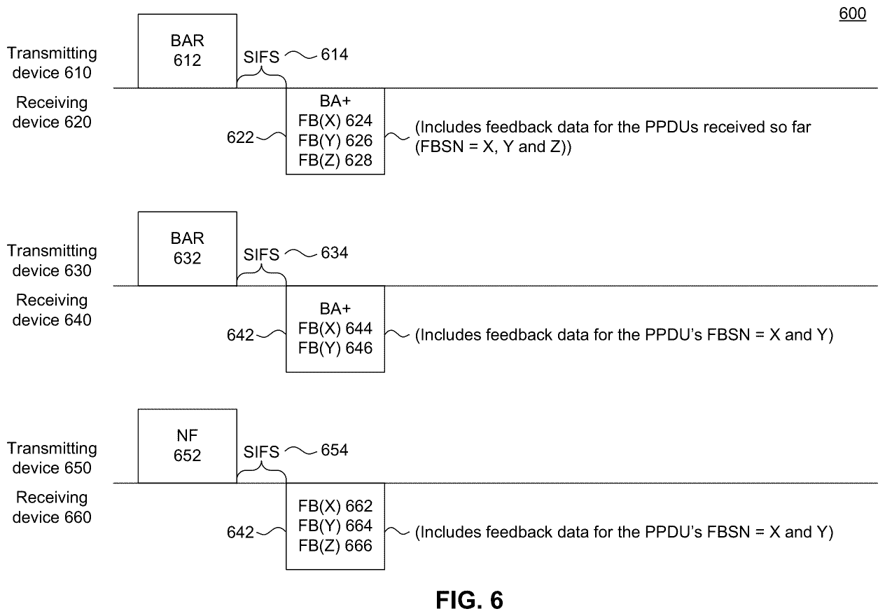

FIG. 6 illustrates an example of variations 600 in transmitting the BAR frames, according to some aspects of the disclosure. For explanation purposes and not a limitation, FIG. 6 can be described with reference to elements from FIG. 1, FIG. 4B, and/or FIG. 5B. For example, a transmitting device 610, 630, and 650 can be the AP STA 110, the transmitting device 410, or the transmitting device 510. A corresponding receiving device 620, 640, 660 can be the non-AP STA 150, receiving device 450, or the receiving device 550, respectively. Conversely, the transmitting device 610, 630, and 650 can be the non-AP STA 150, receiving device 450, or the receiving device 550. A corresponding receiving device 620, 640, 660 can be the AP STA 110, the transmitting device 410, or the transmitting device 510, respectively.

As explained in FIGS. 4A, 4B, 5A and 5B, in some aspects, in response to the reception of the BAR frames 420 and 522, the receiving device 450 and 550 can transmit the BA frame 470 including FBSN (X) and respective FB data and BA frame 570 including FBSN (X) an respective FB data corresponding to a last PPDU of the PPDUs from the respective transmitting device 410, 510 that is successfully received (e.g., decoded) received by the receiving device 450 and 550.

In some aspects, a BAR frame 612 from a transmitting device 610 can request FBSN and FB data corresponding to the following: i) PPDUs received from transmitting device 610 in which the PPDUs have different FBSNs; ii) PPDUs received from transmitting device 610 within a predetermined period; and/or iii) PPDUs received from transmitting device 601 for which receiving device 620 has not yet sent FB data. For example, receiving the BAR frame 612 that indicates requests for i, ii, and/or iii, receiving device 620 can transmit BA information and fast FB contents FB(X) 624, FB(Y) 626, and FB(Z) 628 in a BA frame 622 to the transmitting device 610. For example, FB(X) 624 can include FBSN (X) and corresponding FB data, FB(Y) 626 can include FBSN (Y) and corresponding FB data, and FB(Z) 624 can include FBSN (Z) and corresponding FB data. In some aspects, receiving device 620 can transmit BA frame 622 including the FB(X) 624, FB(Y) 626, and FB(Z) 628 after SIFS 614.

In some aspects, a BAR frame (or multi-user (MU)-BAR frame) 632 from a transmitting device 630 can request FBSN and FB data corresponding to specific FBSNs. For example, the transmitting device 630 can transmit a BAR/MU-BAR frame 632 indicating FBSN(s) (e.g., FBSN X and FBSN Y). In response to receiving the BAR/MU-BAR frame 632, a receiving device 640 can transmit BA frame 642 that includes BA information and fast FB contents FB(X) 644 and FB(Y) 646, to the transmitting device 630. In some aspects, receiving device 640 can transmit BA frame 642 including the FB(X) 644 and FB(Y) 646 to the transmitting device 630 after SIFS 634.

In some aspects, a transmitting device 650 can request (e.g., poll) FBSN and FB data corresponding to specific FBSNs using a different type of frame that does not correspond to a BA frame or a NACK frame. For example, a transmitting device 650 can transmit a new frame (NF) 652 requesting FB data corresponding to PPDUs associated with FBSN X, FBSN Y, and FBSN Z. In response to the receipt of the NF 652, a receiving device 660 can transmit fast FB contents FB(X) 662, FB(Y) 664, and FB(Z) 666 to the transmitting device 650. In some aspects, receiving device 660 can transmit the FB(X) 662, FB(Y) 664, and FB(Z) 666 to the transmitting device 650 to the transmitting device 650 after SIFS 654. In some aspects, BAR frames, MU-BAR frames, and NFs can be referred to as signal frames.

In some aspects, the BAR frame 420, 522, 612, or 632 can be an MU-BAR transmitted to multiple receiving devices that indicates which FB data the transmitting device requests by indicating specific FBSN(s). In some aspects, a BAR frame or MU-BAR frame can indicate a type of FB data in addition to the corresponding FBSN.

In some aspects, the transmitting device 410, 510, 610, 630, or 650 can transmit multiple BARs or NFs other than the BAR frames 420, 522, 612, 632, and the NF 652. In some aspects, the transmitting device 410, 510, 610, 630, or 650 can transmit additional PPDUs with a different parameter (e.g., transmit the PPDU to a different user group in MU-multiple input multiple output (MIMO) or using a different resource unit (RU)).

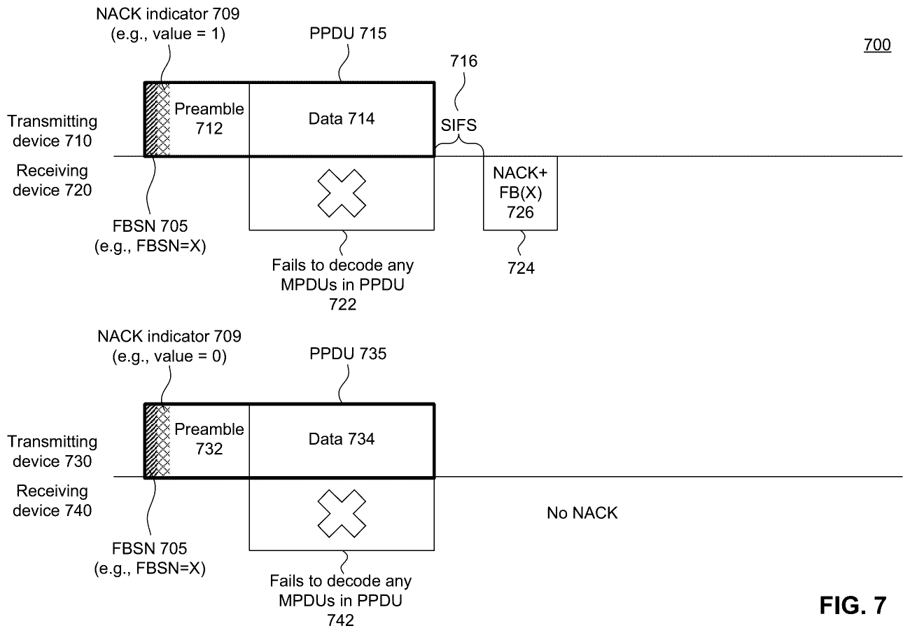

FIG. 7 illustrates an example of WLAN link adaptation flow 700 when a preamble of the PPDU includes a NACK indicator, according to some aspects of the disclosure. For explanation purposes and not a limitation, FIG. 7 can be described with reference to elements from FIG. 1. For example, a transmitting device 710 or 730 can be the AP STA 110 or the non-AP STA 150. A receiving device 720 or 740 can be the non-AP STA 150 or the AP STA 110, respectively.

In WLAN link adaptation flow 700, the transmitting device 710 transmits a PPDU 715 with a preamble 712 and data 714 to the receiving device 720. In some aspects, the PPDU 715 can be a single user (SU)-PPDU. The preamble 712 contains an FBSN 705 which indicates that the FBSN for the PPDU 715 is “X”. In some aspects, the preamble 712 further contains a NACK indicator 709 such as a one bit indicator that informs the receiving device 720 whether there is an immediate BA frame, or a NACK frame (e.g., after a SIFS after the PPDU 715 is received).

In some aspects, a NACK indicator 709 can be set (e.g., value=1) in a preamble 712, and the receiving device 720 transmits the NACK frame 724 (e.g., after receiving the PPDU 715 and/or after receiving the PPDU 715 and after the SIFS 716). For example, receiving device 720 receives the preamble 712 and the data 714, but as shown in operation 722, the receiving device 720 fails to decode at least one of the MPDUs of the data 714. The receiving device 720 transmits a NACK frame 724 and fast FB contents FB(X) 726 after (e.g., immediately after) the elapse of a SIFS 716, the period following the PPDU 715, to the transmitting device 710 in response to the NACK indicator 709 being set (e.g., value=1) and the failure to decode an MPDU. The FB(X) 726 corresponds to the FBSN 705, X, where X is an integer, indicated in the preamble 712. Thus, the transmitting device 710 can determine that the receiving device 720 failed to decode any MPDUs of the data 714. Using the link adaptation parameters of FB(X) 726, transmitting device 710 can configure transmission parameters for sending the next PPDU to receiving device 720. In some aspects, the receiving device 720 can transmit the NACK frame 724 without the FB(X) 726.

In some aspects, the receiving device 720 can transmit a BA frame (not shown) with BA information and the FB(X) 726 in response to the NACK indicator 709 being set (e.g., value=1) and the MPDUs in the PPDU 715 being correctly received (e.g., decoded).

In some aspects, the NACK indicator 709 value may not be set (e.g., value=0) in a preamble 732. In some aspects, transmitting device 730 can transmit a PPDU 735 with a preamble 732 and data 734 to the receiving device 740 in which the preamble 732 contains a NACK indicator 709 (e.g., with a value of 0). A receiving device 740 receives the preamble 732 and the data 734, but as shown in operation 742, the receiving device 740 fails to receive (e.g., decode) at least one of the MPDUs of the data 734. Consequently, the receiving device 740 may not transmit a NACK frame as shown in FIG. 7.

In some aspects, when the NACK indicator 709 is not set (e.g., value=0) and at least one of the MPDUs is correctly received (e.g., decoded), the receiving device 740 can follow a BA policy corresponding to the correctly received MPDU(s) (not shown). The corresponding BA frame could include for example, fast FB contents corresponding to FBSN (X) and associated FB data.

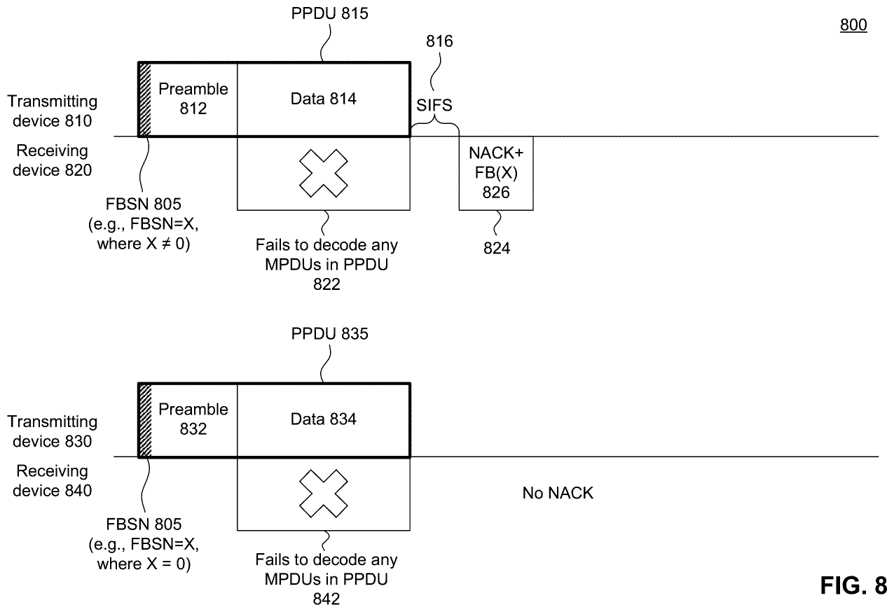

FIG. 8 illustrates an example of WLAN link adaptation flow 800 when a FBSN corresponds to the NACK indicator, according to some aspects of the disclosure. For explanation purposes and not a limitation, FIG. 8 can be described with reference to elements from FIG. 1. For example, a transmitting device 810 or 830 can be the AP STA 110 or the non-AP STA 150, and a receiving device 820 or 840 can be the non-AP STA 150 or the AP STA 110, respectively.

The WLAN link adaptation flow 800, mirrors the WLAN link adaptation flow 700 when the FBSN 805 corresponds to the NACK indicator. For example, when FBSN=0 can correspond to the NACK indicator not being set (e.g., value=0). And, when FBSN does not equal 0 can correspond to the NACK indicator being set (e.g., value=1).

In some aspects, the transmitting device 810 transmits a PPDU 815 with a preamble 812 and data 814 to the receiving device 820. In some aspects, the PPDU 815 can be an SU-PPDU. The preamble 812 contains an FBSN 805 which indicates that the FBSN for the PPDU 815 is “X” where X is a non-zero value, which is equivalent to a NACK indicator with a set value (e.g., value=1). The NACK indicator's characteristics are explained in the description of the FIG. 7 and are not repeated here.

A receiving device 820 receives the preamble 812 and the data 814, but as shown in operation 822, fails to decode at least one of the MPDUs of the data 814. The receiving device 820 transmits a NACK frame 824 with fast FB contents FB(X) 826 (e.g., immediately after a SIFS 816, the period following the PPDU 815) to the transmitting device 810. The FB(X) 826 corresponds to the FBSN 805 indicated in the preamble 812. The transmitting device 810 can receive the NACK frame 824 and the FB(X) 826, determine that the receiving device 820 failed to decode any MPDUs in the PPDU 815, and update the transmission parameters for sending the next PPDU to receiving device 820 according to the link adaptation parameters in the FB(X) 826. In some aspects, the receiving device 820 can transmit the NACK frame 824 without the FB(X) 826.

In some aspects, the receiving device 820 can transmit a BA frame with the FB(X) 826 in response to the FBSN X being non-zero (e.g., NACK indicator with set value (e.g., value=1)) and the MPDUs in the PPDU 815 being correctly decoded.

In some aspects, transmitting device 830 can transmit a PPDU 835 with a preamble 832 and data 834 to the receiving device 840 when the preamble 832 contains an FBSN 805 with a value of 0 (which corresponds to NACK indicator not being set (e.g., NACK indicator value=0). A receiving device 840 receives the preamble 832 and the data 834, but as shown in operation 842, fails to decode at least one of the MPDUs of the data 834. Consequently, receiving device 840 does not transmit a NACK frame as shown in FIG. 8.

In some aspects, when FBSN 805 X being equal 0 and at least one of the MPDUs of the data 834 is received correctly (e.g., decoded correctly), the receiving device 840 can follow a BA policy corresponding to the correctly received MPDU(s) and FBSN (X).

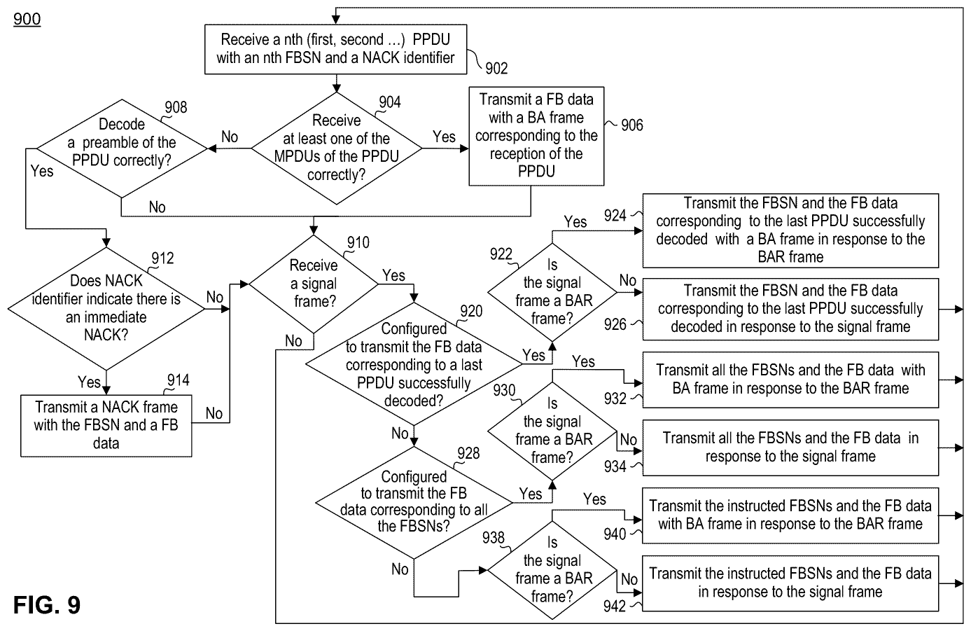

FIG. 9 illustrates an example method 900 for a receiving device in a WLAN link adaptation, according to some aspects of the disclosure. For explanation purposes and not a limitation, method 900 can be described with reference to elements from FIGS. 1, 2, 3A, 3B, 4A, 4B, 5A, 5B, 6-8. For example, method 900 can be performed by wireless device 200 of FIG. 2 or a receiving device including but not limited to the non-AP STA 150, or the receiving devices 350, 450, 550, 620, 640, 660, 720, 740, 820, or 840. The receiving device can communicate with a transmitting device, including but not limited to the AP STA 110, or the transmitting devices 310, 410, 510, 610, 630, 650, 710, 730, 810, or 830.

At operation 902, the receiving device receives a PPDU (e.g., the PPDUs 315, 415, 515, 521, 715, 735, 815, or 835 with corresponding preambles 312, 412, 512, 518, 712, 732, 812, or 832 and data 314, 414, 514, 520, 714, 734, 814, or 834) with an FBSN (e.g., FBSN 305, 405, 505, 705, 805) and/or a NACK indicator. In some aspects, the operation of the receiving device can return to operation 902 multiple times, so the receiving device can receive the first PPDU with the first FBSN, the second PPDU with the second FBSN depending on the number of returns.

At operation 904, the receiving device determines whether the receiving device received (e.g., decoded) at least one of the MPDUs of the PPDU correctly. If the receiving device determines that the receiving device received the PPDU correctly, method 900 proceeds to operation 906. Otherwise, method 900 proceeds to operation 908.

At operation 906, the receiving device transmits the FBSN and corresponding FB data with BA information in a BA frame (e.g., the BA frame 352) corresponding to the reception of the PPDU. In some aspects, the receiving device can transmit the FBSN and corresponding FB data in the BA frame (e.g., FBSN (X) and respective FB data in BA frame 352). The receiving device then proceeds to operation 910.

At operation 908, the receiving device determines whether the receiving device received a preamble of the PPDU correctly. If the receiving device determines that the receiving device received the preamble of the PPDU correctly (e.g., 440a of FIG. 4A), method 900 proceeds to operation 912. If the receiving device determines that the receiving device did not receive the preamble of the PPDU correctly (e.g., 560a of FIG. 5A), method 900 proceeds to operation 910.

At operation 912, the receiving device determines whether the NACK indicator is set (e.g., value=1 or FBSN value is non-zero). When the NACK indictor is set (e.g., the preambles 712 or 812), method 900 proceeds to operation 914. Otherwise, method 900 proceeds to operation 910.

At operation 914, the receiving device transmits a NACK frame with the FBSN and a FB data (e.g., the NACK frame 724 or 824, and the FB(X) 726 or 826). In some aspects, the receiving device can transmit the NACK frame 724 without the FB(X) 726 or 826. The receiving device then proceeds to operation 910.

At operation 910, the receiving device determines whether the receiving device receives a signal frame requesting feedback information (e.g., the BAR frame 420, 522, 612, 632, or the NF 652). If the receiving device determines that the receiving device does not receive a signal frame method 900 returns to operation 902. Otherwise, method 900 proceeds to 920.

At operation 920, the receiving device determines whether the receiving device is configured to transmit the FB data corresponding to a last PPDU successfully received (e.g., the BAR frame 420, 522, 612, 632 or NF 652). If the receiving device is configured to transmit the FB data corresponding to a last PPDU successfully received, method 900 proceeds to 922. Otherwise, method 900 proceeds to operation 928.

At operation 922, the receiving device determines the signal frame is a BAR frame. When the signal frame is a BAR frame, method 900 proceeds to operation 924. Otherwise, method 900 proceeds to operation 926.

At operation 924, the receiving device transmits the FBSN and a FB data corresponding to the last PPDU successfully decoded within a BA frame (e.g., the BA frame 470 or 570) in response to the BAR frame. The receiving device returns to operation 902.

At operation 926, the signal frame is not a BAR frame (e.g., the NF 652) and the receiving device transmits the FBSN and a FB data last PPDU successfully decoded in response to the signal frame. The receiving device returns to operation 902.

At operation 928, the receiving device determines whether the receiving device is configured to transmit the FB data corresponding to all the FBSNs received from the same transmitting device. If the receiving device determines the receiving device is configured to transmit the FB data corresponding to all the FBSNs received so far, method 900 proceeds to operation 930. Otherwise, method 900 proceeds to 938.

At operation 930, the receiving device determines whether the signal frame is a BAR frame. If the receiving device determines that the signal frame is a BAR frame (e.g., the BAR frame 420, 522, 612, or 632), method 900 proceeds to operation 932.

At operation 932, the receiving device transmits the FBSN, and a FB data corresponding to all the FBSNs received so far (e.g., the FB(X) 624, FB(Y) 626, and FB(Z) 628) within a BA frame (e.g., the BA frame 622) in response to the BAR frame. The receiving device returns to operation 902.

At operation 934, the signal frame is not a BAR frame (e.g., the NF 652) and the receiving device transmits the FBSN and a FB data corresponding to all the FBSNs received so far in response to the signal frame. The receiving device returns to operation 902.

At operation 938, the receiving device can be configured to transmit the FB data corresponding to FBSNs as instructed in the signal frame. The receiving device determines whether the signal frame is a BAR frame. When the signal frame is a BAR frame, method 900 proceeds to operation 940. Otherwise, method 900 proceeds to operation 942.

At operation 940, the signal frame is a BAR frame (e.g., the BAR frame 420, 522, 612, or 632) and the receiving device transmits the FBSN and a FB data (e.g., the FB(X) 644 and FB(Y) 646) corresponding to FBSNs indicated in the BAR/MU-BAR frame within a BA frame (e.g., the BA frame 642) in response to the BAR frame. The receiving device returns to operation 902.

At operation 942, the signal frame is not a BAR frame (e.g., the signal frame can be the NF 652), and the receiving device transmits the FBSN and a FB data (e.g., the FB(X) 662, FB(Y) 664, and FB(Z) 666) corresponding to the instructions in the signal frame. The method 900 returns to operation 902.

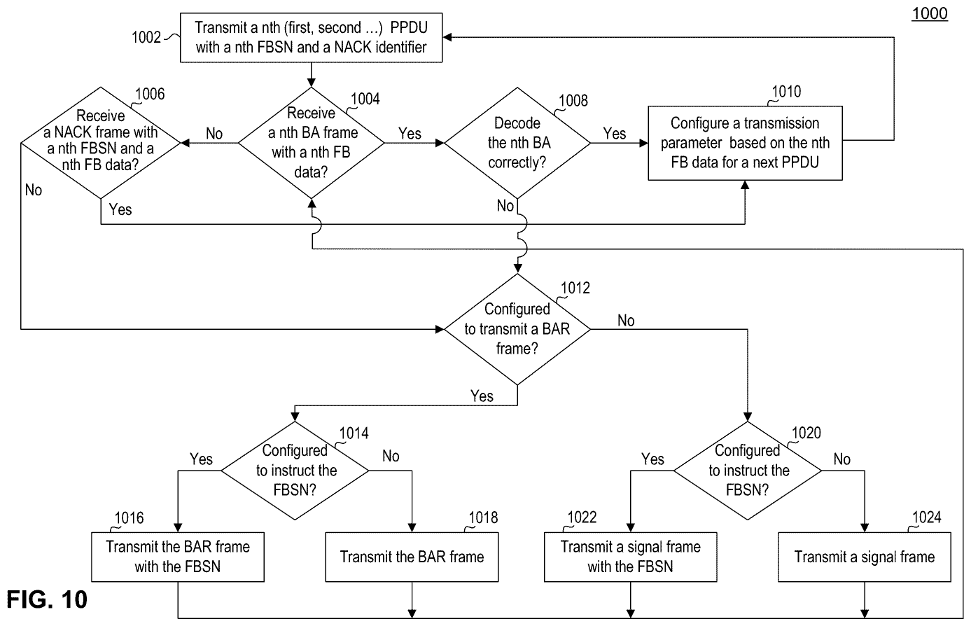

FIG. 10 illustrates an example method 1000 for a transmitting device in a WLAN link adaptation, according to some aspects of the disclosure. For explanation purposes and not a limitation, method 1000 can be described with reference to elements from FIGS. 1-8. For example, method 1000 can be performed by wireless device 200 of FIG. 2, or a transmitting device including but not limited to the AP STA 110, or the transmitting devices 310, 410, 510, 610, 630, 650, 710, 730, 810, or 830. The transmitting device can communicate with a receiving device including but not limited to the non-AP STA 150, or the receiving devices 350, 450, 550, 620, 640, 660, 720, 740, 820, or 840.

At operation 1002, the transmitting device transmits a PPDU (e.g., the PPDUs 315, 415, 515, 521, 715, 735, 815, or 835 with the preambles 312, 412, 512, 518, 712, 732, 812, or 834 and data 314, 414, 514, 520, 714, 734, 814, or 834) with an FBSN and/or a NACK indicator. In some aspects, the operation of the transmitting device can return to operation 1002 multiple times, so the receiving device can transmit the first PPDU with the first FBSN and the second PPDU with the second FBSN, and return to operation 1002.

At operation 1004, the transmitting device determines whether the transmitting device receives a BA frame with a FB data. When the BA frame includes FB data corresponding to the FBSN transmitted at operation 1002, method 1000 proceeds to operation 1008. Otherwise, method 1000 proceeds to operation 1006.

At operation 1006, the transmitting device determines whether the transmitting device receives a NACK frame with the FBSN and the FB data. If the transmitting device determines that the transmitting device receives the NACK frame with the FBSN and the FB data the transmitting device proceeds to operation 1010. If the transmitting device determines that the transmitting device does not receive the NACK frame including the FBSN and the FB data, the method 1000 proceeds to operation 1012.

At operation 1008, the transmitting device determines whether the transmitting device received the BA frame correctly. If the transmitting device determines that the transmitting device received the BA correctly (e.g., the BA frame 470 or 570), method 1000 proceeds to operation 1010. Otherwise, method 1000 proceeds to operation 1012.

At operation 1010, the transmitting device configures a transmission parameter based on the FB data (e.g., link adaptation parameters) received from a receiving device for a next PPDU directed to the receiving device. The transmitting device returns to operation 1002.

At operation 1012, the transmitting device did not decode the BA frame correctly (e.g., the operation 418) or the transmitting device determines that the transmitting device does not receive the NACK frame with the FBSN and the FB data, and the transmitting device determines whether the transmitting device is configured to transmit a BAR frame as a signal frame. If the transmitting device is configured to transmit a BAR frame as a signal frame, transmitting device proceeds to operation 1014. Otherwise, method 1000 proceeds to operation 1020.

At operation 1014, the transmitting device determines whether the transmitting device is configured to instruct the receiving device to provide FB data corresponding to an FBSN. When the transmitting device determines that the transmitting device is configured to instruct the receiving device to provide FB data corresponding to one or more FBSN, method 1000 proceeds to operation 1016. Otherwise, method 1000 proceeds to operation 1018.

At operation 1016, the transmitting device transmits the BAR frame with instructions regarding requesting FB data corresponding to FBSN (e.g., the BAR frame 632), and method 1000 returns to operation 1004.

At operation 1018, the transmitting device transmits the BAR frame (e.g., the BAR frame 420, 522, or 612) without instructions regarding particular FBSNs and corresponding FB data. In some aspects, the configuration regarding providing instructions regarding the FBSN and the FB data can be configured during association. The method 1000 returns to operation 1004.

At operation 1020, the transmitting device determines whether the transmitting device is configured to instruct the receiving device to provide FB data corresponding to an FBSN. When the transmitting device determines that the transmitting device is configured to instruct the receiving device to provide FB data corresponding to one or more FBSN, method 1000 proceeds to operation 1022. Otherwise, method 1000 proceeds to operation 1004.

At operation 1022, the transmitting device transmits a signal frame with instructions regarding requesting FB data corresponding to FBSN (e.g., NF 652), and method 1000 returns to operation 1004.

At operation 1024, the transmitting device transmits the signal frame (e.g., NF 652) without instructions regarding particular FBSNs and corresponding FB data. In some aspects, the configuration regarding providing instructions regarding the FBSN and the FB data can be configured during association. The method 1000 returns to operation 1002.

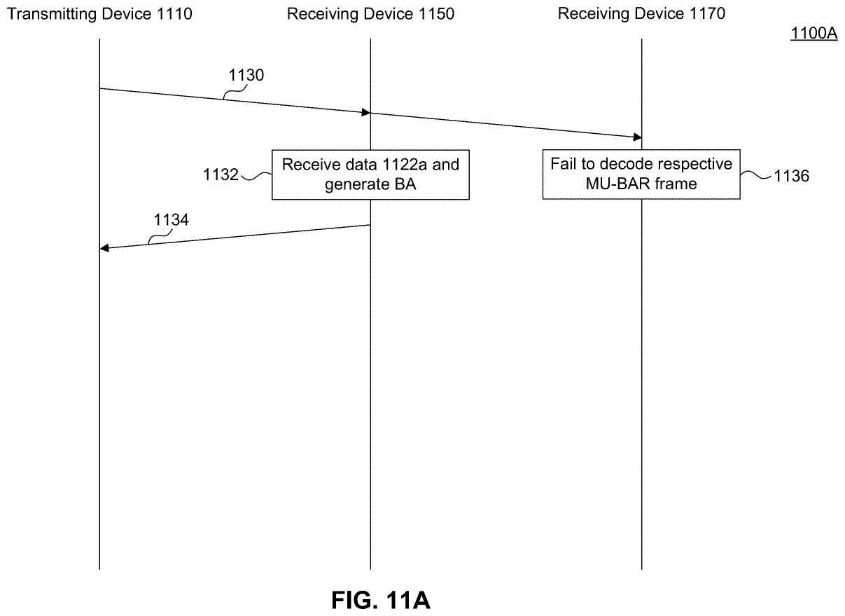

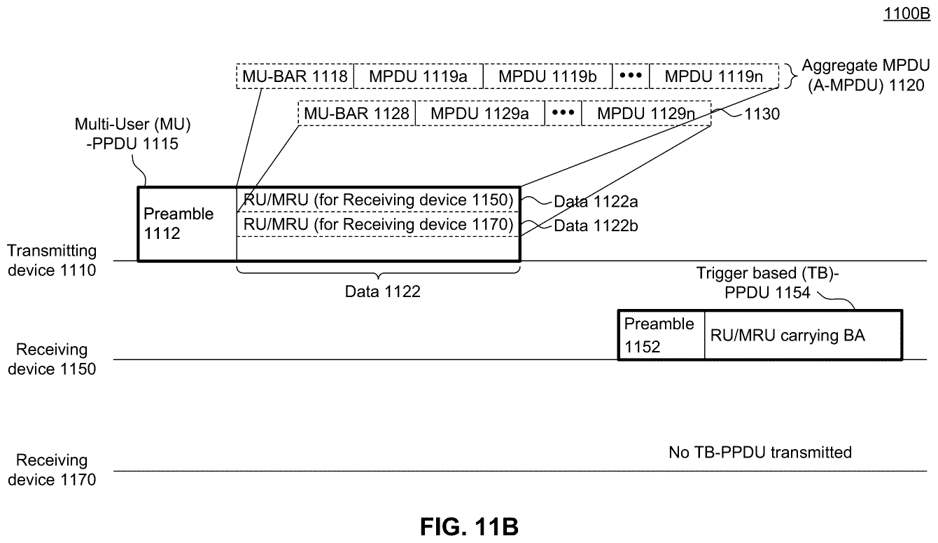

As explained in FIG. 7 for transmitting PPDU 715 to a single user (e.g., a SU-PPDU), if the receiving device 720 could not decode even a single MPDU, the receiving device 720 could send fast FB contents FB(X) that includes the FBSN 705 and corresponding FB data to the transmitting device 710 in response to receiving the NACK indicator 709. In some examples, a transmitter may transmit a PPDU to multiple users (e.g., a multi-user (MU) PPDU). However, if a transmitting device transmits individual MPDUs to multiple receiving devices in a single data frame, a receiving device of the multiple receiving devices may not be able to transmit fast FB contents properly to the transmitting device, even with the NACK indicator. This issue is explained using FIGS. 11A and 11B.

FIGS. 11A and 11B illustrate examples of WLAN link adaptation flows 1100A and 1100B including a multi-user (MU)-PPDU, according to some aspects of the disclosure. For explanation purposes and not a limitation, FIGS. 11A and 11B can be described with reference to elements from FIG. 1. For example, a transmitting device 1110 can be the AP STA 110, and the receiving devices 1150 and 1170 can be the non-AP STA 150 or the non-AP STA 170 of FIG. 1. Other combinations are possible.

WLAN link adaptation flow 1100A is illustrated another way with additional details in the WLAN link adaptation flow 1100B and can be described as follows:

At 1130, the transmitting device 1110 can transmit data to multiple receiving devices, including the receiving device 1150 and the receiving device 1170, via an MU-PPDU 1115. MU-PPDU 1115 can include a preamble 1112 and data portion 1122. Data portion 1122 can include data corresponding to particular receiving devices (e.g., data 1122a corresponding to receiving device 1150 and data 1122b corresponding to receiving device 1170).

The data portions 1122a and 1122b can be transmitted to a respective receiving devices in various frequency bands in resource units (RUs) or multiple resource units (MRUs). As an example, the data portion transmitted by the RU/MRU assigned to the receiving device 1150 is referred to as a data 1122a. The data 1122a can include an MU-BAR frame 1118 and MPDUs 1119a-1119n. The MU-BAR frame 1118 and the MPDUs 1119a-1119n can collectively be referred to as an aggregate (A)-MPDU 1120. The data portion transmitted by the RU/MRU assigned to the receiving device 1170 is referred to as a data 1122b. The data 1122b can include an MU-BAR frame 1128 and MPDUs 1129a-1129n. The MU-BAR frame 1128 and the MPDUs 1129a-1129n can collectively be referred to as an aggregate (A)-MPDU 1130. The preamble 1112 can indicate how to decode the data 1122 (e.g., data 1122a, data 1122b, etc.).

At 1132, receiving device 1150 receives data 1122a and generates BA information according to the MU-BAR frame 1118. The MU-BAR frame 1118 can specify parameters relating to the RU/MRU to be used by the receiving device 1150 for generating and transmitting a trigger-based (TB)-PPDU 1154 that includes BA information corresponding to the data 1122a of MU-PPDU 1115 received. The MU-BAR frame 1118 can trigger a transmission of the TB-PPDU 1154a.

At 1134, the receiving device 1150 can transmit the TB-PPDU 1154 that includes a preamble 1152 and BA information using a specific RU or MRU corresponding the receipt of data 1122a of the MU-PPDU 1115.

Data 1122b can include respective MU-BAR frame 1128. If receiving device 1170 receives and decodes data 1122b, then receiving device 1170 can use MU-BAR frame 1128 information to generate and transmit a respective TB-PPDU including a preamble and BA information, using a specific RU or MRU.

At 1136, the receiving device 1170 cannot decode the respective MU-BAR frame, the receiving device 1170 cannot determine how and where to transmit a respective TB-PPDU. For example, the receiving device 1170 may not determine the RU allocation assigned to the receiving device 1170 in the respective MU-BAR trigger frame. To address this issue, a physical layer (PHY) MU-BAR frame can be included in a preamble of the MU-PPDU.

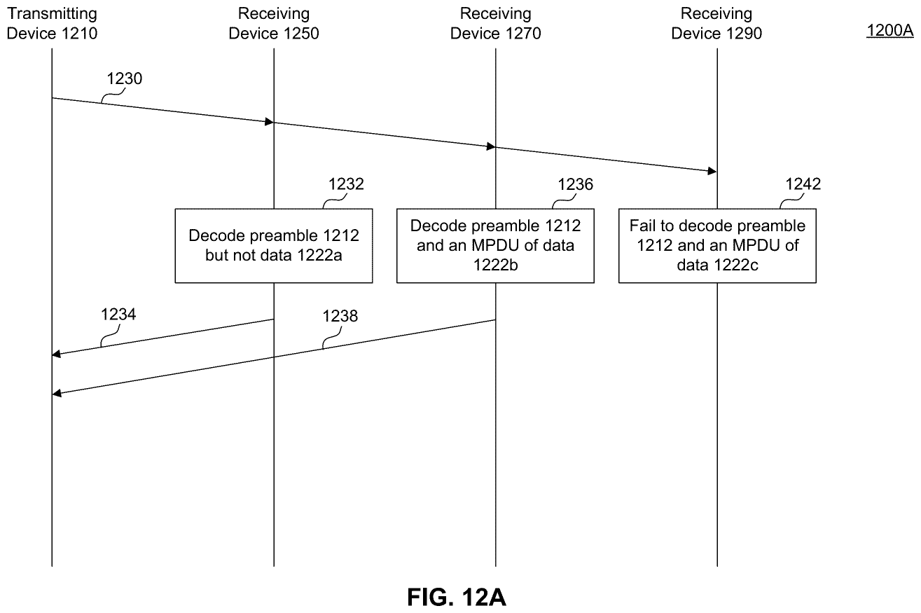

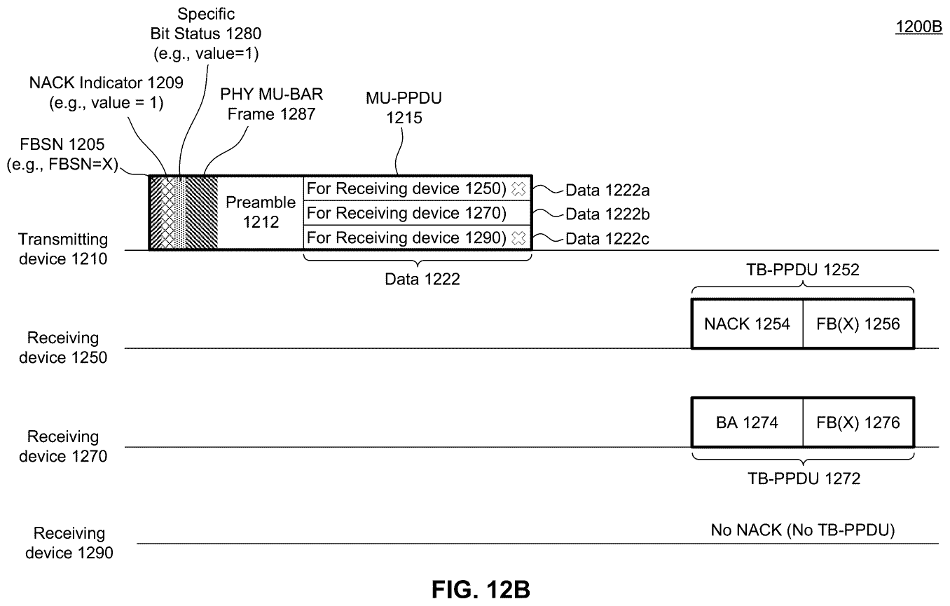

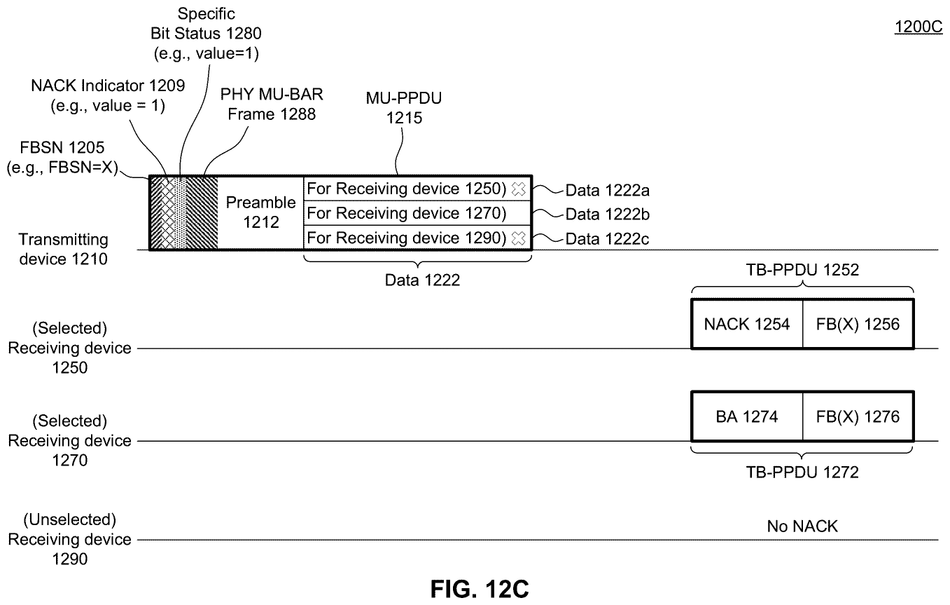

FIGS. 12A, 12B, and 12C illustrate examples of WLAN link adaptation flows 1200A, 1200B, and 1200C including a PHY MU-BAR frame, according to some aspects of the disclosure. For explanation purposes and not a limitation, FIGS. 12A, 12B, and 12C can be described with reference to elements from FIG. 1. For example, a transmitting device 1210 can be the AP STA 110 receiving devices 1250 and 1270 can be the non-AP STA 150 and the non-AP STA 170, respectively. Receiving device 1290 can be another non-AP STA (not shown). Other combinations are possible.

WLAN link adaptation flow 1200A is illustrated below and may be described with details from the WLAN link adaptation flows 1200B and 1200C as described below.

At 1230, transmitting device 1210 can transmit a MU-PPDU 1215 including a preamble 1212 and data portions 1222 including data 1222a, data 1222b, and data 1222c (see FIG. 12B and FIG. 12C) to multiple receiving devices, including receiving devices 1250, 1270, and 1290. The preamble 1212 can also include the FBSN 1205 explained with reference to FIGS. 3A, 3B, 4A, 4B, 5A, 5B, and 6-8. The preamble 1212 can also include the NACK indicator 1209 explained with reference to FIG. 7.

As explained with reference to operation 1136 of FIG. 11A, if a receiving device 1170 could not decode MU-BAR frame 1118 successfully, the receiving device 1170 cannot determine how to transmit the respective TB-PPDU. To address this issue, as shown in FIG. 12B, the preamble 1212 can include a PHY MU-BAR frame 1287 to inform the receiving devices 1250, 1270 and 1290 of how to transmit the TB-PPDUs 1252, 1272 and 1292 (not shown). TB-PPDU 1292 is absent in FIG. 12B since receiving device 1290 failed to decode Preamble 1212 including PHY MU-BAR frame 1287.

For example, the preamble 1212 can include a PHY MU-BAR frame 1287 (e.g., in an ultra-high reliability (UHR)-signal field (SIG)). The PHY MU-BAR frame 1287 may be included in a field other than the UHR-SIG. The PHY MU-BAR frame 1287 can have similar functionality to a MU-BAR frame (e.g., MU-BAR frame 1118 in data 1122a of FIG. 11B), but differs from the MU-BAR frame in that it can be included in the physical layer preamble 1212, instead of within data 1222a. The PHY MU-BAR frame 1287 can indicate parameters for transmitting trigger-based (TB)-PPDUs 1252 and 1272. For example, the PHY MU-BAR frame 1287 can specify parameters relating to the RU/MRU to be used for transmitting a TB-PPDUs 1252 and 1272 transmitted by the receiving devices 1250 and 1270, respectively, with BA information corresponding to the receipt of data 1222a and data 1222b of MU-PPDU 1215.

At 1232, the receiving 1250 device receives MU-PPDU 1215 and decodes the preamble 1212. But, the receiving device 1250 cannot decode any MPDUs in data 1222a.

At 1234, the receiving device 1250 can transmit a TB-PPDU 1252 including a NACK frame 1254 with fast FB contents FB(X) 1256 that includes FBSN X and FB data corresponding to data 1222a, and based on the parameters indicated in the PHY MU-BAR frame 1287 as an immediate feedback. Thus, the transmitting device 1210 can determine in response to receiving the TB-PPDU 1252 including the NACK frame 1254 with FB(X) 1256, that the receiving device 1250 failed to decode the MPDUs of data 1222a. In addition, the transmitting device 1210 can configure, based at least on the FB data included in the FB(X) 1256, a transmission parameter for a next PPDU directed to the receiving device 1250.

At 1236, the receiving 1270 device successfully decodes at least one MPDU in data 1222b.

At 1238, the receiving device 1270 can transmit a TB-PPDU 1272 including a BA frame 1274 with FB(X) 1276 that includes FBSN X and FB data corresponding to data 1222b received. The PHY MU-BAR frame 1287 of preamble 1212 informs the receiving device 1270 to transmit the TB-PPDU 1272 including BA frame 1274 and fast FB contents FB(X) 1276. In this way, the transmitting device 1210 can determine that the receiving device 1270 successfully decoded the MPDUs in data 1222b. In addition, the transmitting device 1210 can configure, based at least on the FB data included in the FB(X) 1276, a transmission parameter for a next PPDU directed to the receiving device 1270. In some examples, data 1222a and 1222b can include respective MU-BAR frames (not shown).

The transmitting device can indicate implicitly or explicitly that the PHY MU-BAR frame 1287 is included in the preamble 1212. As such, to the receiving devices 1250 and 1270 can determine whether to transmit the TB-PPDU 1252 or 1272 in response to the PHY MU-BAR frame 1287. There can be multiple ways to indicate to the receiving devices 1250 and 1270 that the PHY MU-BAR frame 1287 is included in the preamble 1212 (e.g., UHR-SIG). In some aspects, the existence of the PHY MU-BAR frame 1287 can be implicitly indicated as being included in a UHR-SIG of MU-PPDU 1215 if the NACK indicator 1209 in preamble 1212 is set to a specific value (e.g., 1) and a number of user info fields in the preamble 1212 is greater than a specific value (e.g., 1). In other words, if the number of user information fields is greater than one, then there is more than one receiving device. The user info field can indicate specific user information corresponding to a specific receiving device.

In some aspects, the existence of the PHY MU-BAR frame 1287 can be explicitly indicated as being included in the UHR-SIG of MU-PPDU 1215 if a specific bit status 1280 (e.g., a status of a “PHY MU-BAR frame present” bit) in the preamble 1212 is set to a specific value (e.g., 1) and the NACK indicator 1209 in the preamble 1212 is set to a specific value (e.g., 1). Where the specific bit status 1280 is used, if the NACK indicator 1209 in preamble 1212 is not set to the specific value (e.g., 0), the specific bit status 1280 can be reserved (e.g., when the specific bit status 1280 has a value=0, the specific bit status 1280 is not used to indicate the presence of PHY MU-BAR frame 1287). Thus, the combination of the NACK indicator 1209 (e.g., 0) and the specific bit status 1280 (e.g., 0), can indicate that the PHY MU-BAR frame 1287 is not present in the UHR-SIG of MU-PPDU 1215. In an example, when the specific bit status 1280 is set to a specific value (e.g., 1) and the NACK indicator 1209 is not set to the specific value (e.g., 0), the combination of the specific bit status 1280 and the NACK indicator 1290 can indicate that the PHY MU-BAR frame 1287 is not present in the UHR-SIG of MU-PPDU 1215.

The PHY MU-BAR frame 1287 can indicate information common to the multiple receiving devices 1250 and 1270 and information directed specifically to the individual receiving devices 1250 or 1270. In this way, data common to the receiving devices can be efficiently transmitted and the receiving devices can be controlled individually. As explained, the PHY MU-BAR frame 1287 can include parameters for transmitting TB-PPDUs 1252 and 1272. The parameters can be expressed by a common info subfield and a respective user info subfield of the PHY MU-BAR frame 1287. The common info subfield can indicate information common to all receiving devices. The user info subfield can indicate specific information associated with a specific receiving device. The common info subfield and the user info subfield can include at least one of the subfields used in the common info subfield or the user info subfield of a trigger frame (e.g., MU-BAR frame 1118 of FIG. 11B). As such, the PHY MU-BAR frame 1287 can trigger the TB-PPDUs 1252 and 1272 individually.

Assuming that the transmission from the transmitting device 1210 to the receiving devices 1250, 1270 is an downlink (DL) communication, the common info subfield can include one or more of the following parameters: Uplink (UL) length (12 bits), AP transmission (Tx) Power (6 bits), Low-density parity check (LDPC) Extra Symbol Segment (1 bit), Pre-forward error correction (FEC) Padding Factor (2 bits) and Packet extension (PE) Disambiguity (1 bits), for a total of 22 bits. Other parameters in the common info subfield of the PHY MU-BAR frame 1287 can be determined based on a common info subfield of a trigger frame (e.g., MU-BAR frame 1118). In some examples, parameters of DL MU-PPDU transmission can be fixed for immediate feedback purposes. For example, a parameter of UL Band Width (BW) can be the same as DL BW. For example, a number of Long Training Field (LTF) symbols can be fixed to one.

Assuming that the transmission from the transmitting device 1210 to the receiving devices 1250, 1270 is a downlink (DL) communication, the user info subfield can include following parameters: Association ID (AID) 12 (12 bits) and/or UL Target Receive Power (7 bits), total 17 bits. The AID 12 can indicate to which AID the RUs are assigned. Other parameters listed in the user info field of the trigger frame (e.g., MU-BAR frame 1118) can be omitted in the user info field of the PHY MU-BAR frame 1287. For example, when receiving the MU orthogonal frequency-division multiple access (OFDMA) PPDU, a same RU allocation as in DL OFDMA PPDU can be assigned to receiving devices for transmitting UL TB-PPDU carrying immediate feedback. In addition, where receiving MU-multiple input multiple output (MIMO) PPDU, predetermined RU allocation (e.g., equal RU allocation if the number of the receiving device is 2, 4, 8, or 16) can be assigned for each of the receiving devices 1250, 1270 for transmitting UL TB PPDUs carrying immediate feedback. (The exact RU location for the receiving devices 1250, 1270 can depend on the order of the receiving devices 1250 and 1270 in the spatial multiplexing). In some examples, a parameter of UL coding type can be fixed to LDPC. A parameter of Number of Spatial Streams can be fixed to one. A parameter of MCS can be fixed to zero.

In some aspects, if the PHY MU-BAR frame 1287 is present in the UHR-SIG of the MU-PPDU 1215, the PHY MU-BAR frame 1287 can be appended at the end of User Specific field of the UHR-SIG before the padding (if the padding is present) using one of the options explained below to transmit. Here, the User Specific field includes information associated with a specific receiving device.

The PHY MU-BAR frame 1287 may trigger the immediate feedback (BA or NACK) from all receiving devices including 1250, 1270 and 1290 (see FIG. 12B) or trigger the immediate feedback from selected receiving devices 1250 and 1270 (see FIG. 12C).

FIG. 12B illustrates example 1200B of a WLAN link adaptation flow where the PHY MU-BAR frame 1287 may trigger the immediate feedback from all receiving devices 1250, 1270, and 1290, according to some aspects of the disclosure. In this case, no Trigger BA frame (e.g., a MU-BAR frame) may be sent in the data 1222a, 1222b, and 1222c. In the event all the receiving devices 1250, 1270, and 1290 decode preamble 1212 including PHY MU-BAR frame 1287, then immediate feedback can be triggered and transmitted from receiving devices 1250, 1270, and 1290 (not shown).

As shown in FIG. 12A at 1242, however, receiving device 1290 cannot decode preamble 1212 so receiving device 1290 cannot transmit a corresponding TB-PPDU.

In some examples, no MU-BAR frames are included in corresponding data portions when the PHY MU-BAR frame 1287 is configured to trigger immediate feedback from all the receiving devices. Thus, no alignment of the MU-BAR frame (e.g., Trigger BA) sent in the data of the MPDU with the PHY MU-BAR frame 1287 is needed which can simplify operations. Triggering the immediate feedback from the all receiving devices can save data 1222 capacity, however, the UHR-SIG may be expanded to accommodate the PHY MU-BAR frame 1287.

The common info subfield of the PHY MU-BAR frame can be present in all UHR-SIG content channels. There can be one or two UHR-SIG content channels in preamble 1212, depending on the PPDU bandwidth. The user info subfield of the PHY MU-BAR frame 1287 can be assigned to the same UHR-SIG content channel where receiving device's user info field is located. An advantage of transmitting the PHY MU-BAR frame 1287 for all receiving devices 1250, 1270, and 1290 is that alignment with a trigger BA frame (e.g., MU-BAR frame 1118) is not needed, because no trigger BA frames (e.g., a MU-BAR frame 1118) need to be sent in the data 1222a, 1222b, and 1222c.

FIG. 12C illustrates an example of a WLAN link adaptation flow where a PHY MU-BAR frame may trigger an immediate feedback from selected receiving devices, according to some aspects of the disclosure. In FIG. 12C, the description of items with reference numbers used in FIGS. 12A and 12B are not repeated. In contrast to FIG. 12B, FIG. 12C illustrates that the PHY MU-BAR frame 1288 triggers immediate feedback from the selected receiving devices 1250 and 1270 but not from the receiving device 1290. For example, an MU-BAR frame (not shown) can be included in data 1222c but user-specific fields corresponding to receiving device 1290 are not included in the PHY MU-BAR frame 1288. In addition, data 1222a and 1222b may not include any corresponding MU-BAR frames.

There may be various criteria for identifying receiving devices 1250 and 1270 as being selected from the receiving devices 1250, 1270 and 1290. For example, a selected receiving device may be selected based on the communication history between the transmitting device 1210 and receiving devices 1250, 1270, and 1290. For example, the selected receiving devices 1250 and 1270 may have had poor quality communications with transmitting device 1210 in the past, and are assumed to continue to have poor quality communications. Thus, receiving devices 1250 and 1270 may be selected to transmit immediate feedback (NACK or BA) in response to the PHY MU-BAR frame 1288. In contrast, the receiving device 1290 may have had high quality or acceptable quality communications with transmitting device 1210 in the past and is assumed to continue similar quality communications. Thus, receiving device 1290 may not be selected to transmit immediate feedback (e.g., NACK or BA) via PHY MU-BAR frame 1288.

The communication history can include past communication statistics indicating whether or not the receiving devices 1250, 1270 and 1290 responded to a trigger frame (e.g., a MU-BAR frame) included in the data portions directed to receiving devices 1250, 1270, and 1290. For example, the transmitting device 1210 may select a receiving device that did not respond to the trigger frame (e.g., MU-BAR frame in a previous communication as the selected receiving device. In another example, the transmitting device 1210 may select a receiving device that did not responded to a MU-BAR frame more than a predetermined number of times in a given number of previous communications.

To trigger the immediate feedback from the selected receiving devices 1250 and 1270, the transmitting device 1220 can configure the common info subfield of the PHY MU-BAR frame 1288 to be present in UHR-SIG content channels referenced by the selected receiving devices 1250 and 1270. Further, to trigger the immediate feedback from the selected receiving devices 1250 and 1270, the transmitting device 1220 can configure the user info subfield of the PHY MU-BAR frame 1288 to be assigned to the same UHR-SIG content channel where receiving device 1250 and 1270's user info field are located. In other words, at least one portion of the PHY MU-BAR frame can be present in the user specific field corresponding to the selected receiving device. As such, the selected devices 1250 and 1270 can transmit the TB-PPDU 1252 and 1272 in response to the PHY MU-BAR frame 1288. As shown in FIG. 12C, the selected receiving device 1250, which fails to decode the data 1222a, can transmit the TB-PPDU 1252 including the NACK frame 1254 with FBSN X and FB data 1256, and the selected receiving device 1270, which successfully decodes the data 1222b, can transmit the TB-PPDU 1252 including the BA frame 1254 with FBSN X and FB data 1276.

To trigger the feedback from the unselected receiving device 1290, the trigger frame can be sent in the data 1222c. As shown in FIG. 12C, the unselected receiving device 1290, which fails to decode the data 1222c, may not transmit the immediate feedback.

In contrast, when the unselected receiving device 1290 successfully decodes the data 1222c and thus, decodes a corresponding MU-BAR frame in data 1222c (not shown), the unselected receiving device 1290 can transmit a TB-PPDU with a BA frame. In some aspects, the common info subfield and/or user info subfield of the trigger frame sent in the data 1222c can be compatible with the common info and user info set in the PHY MU-BAR frame 1288. In other words the user specific field of the PHY MU-BAR frame 1288 and the user specific field of the trigger frame may be at least partially identical. For example, the user specific field of the PHY MU-BAR frame and the user specific field of the trigger BA can include the parameters of the AID 12 (e.g., 12 bits) and the UL Target Receive Power (e.g., 7 bits). In this way, the transmitting device 1210 can share the processing of immediate feedbacks from the selected receiving devices 1250 and 1270 and the processing of feedback from the unselected receiving device 1290.

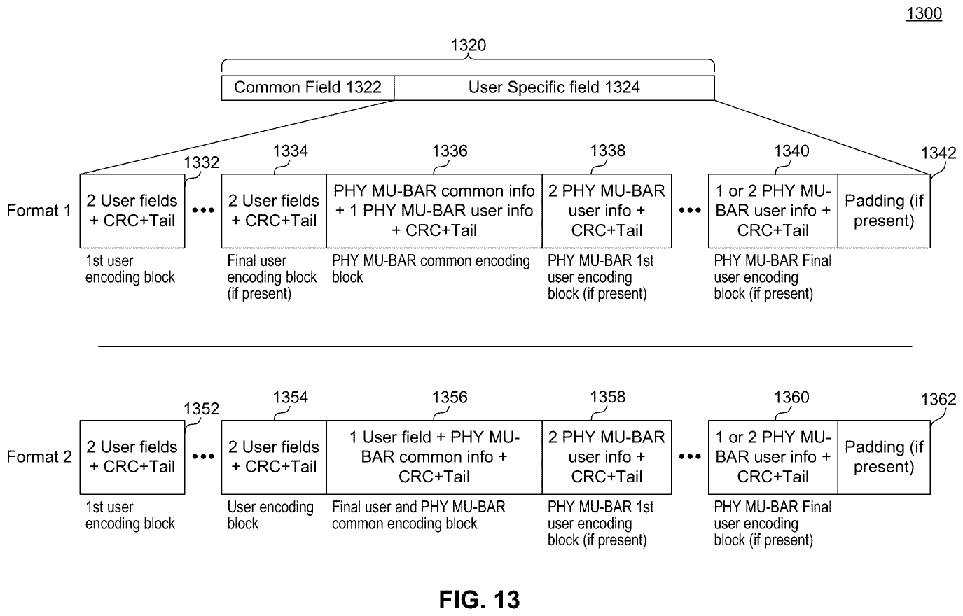

FIG. 13 illustrates an example of ultra-high reliability (UHR)-signal field (SIG) content channel format 1300 where the PHY MU-BAR frame is present in the UHR-SIG, according to some aspects of the disclosure. For example, Format 1 can indicate that there are an even number of users (e.g., even number of receiving devices) scheduled in an MU-PPDU, and Format 2 can indicate that there are an odd number of users scheduled in an MU-PPDU. But, the number of users included in PHY MU-BAR 1287 or 1288 can be all of the users or a portion of the users.

A UHR-SIG content channel 1320 can include a common field 1322 and a user specific field 1324. In FIG. 13 the UHR-SIG content channel 1320 can be referenced by all receiving devices. The user specific field 1324 can have multiple formats depending on a number of user fields in a final user encoding block.

In a format 1, the user specific field 1324 can include user encoding blocks 1332 to 1334. The user encoding blocks 1332 to 1334 can include two user fields, cyclic redundancy check (CRC) bits, and tail bits. The user specific field 1324 can also include a PHY MU-BAR frame common encoding block 1336. The PHY MU-BAR frame common encoding block 1336 can include the PHY MU-BAR frame common info subfield, one of the PHY MU-BAR frame user info subfield, the CRC bits, and the tail bits. The user specific field 1324 can also include PHY MU-BAR frame user encoding blocks 1338 to 1340. The PHY MU-BAR frame user encoding blocks 1338 to 1340 can include one or two of the PHY MU-BAR frame user info subfield(s), the CRC bits, and the tail bits. The user specific field 1324 can also include a padding 1342 if needed.

In a format 2, the user specific field 1324 can include a user encoding blocks 1352 to 1354. The user encoding blocks 1352 to 1354 can include two user fields, cyclic redundancy check (CRC) bits, and tail bits. The user specific field 1324 can also include a final user and PHY MU-BAR frame common encoding block 1356. The final user and PHY MU-BAR frame common encoding block 1336 can include one user field, the PHY MU-BAR frame common info subfield, the CRC bits, and the tail bits. The user specific field 1324 can also include PHY MU-BAR frame user encoding blocks 1358 to 1360. The PHY MU-BAR frame user encoding blocks 1338 to 1340 can include one or two of the PHY MU-BAR frame user info subfield(s), the CRC bits, and the tail bits. The user specific field 1324 can also include a padding 1362 if needed.

In some aspects, when the PHY MU-BAR frame triggers the immediate feedbacks from the selected receiving devices, the PHY MU-BAR frame common encoding block 1336 and the PHY MU-BAR frame user encoding blocks 1338 to 1340, or the PHY MU-BAR frame user encoding blocks 1358 to 1360 corresponding to the selected receiving devices can include the PHY MU-BAR frame user info subfield.

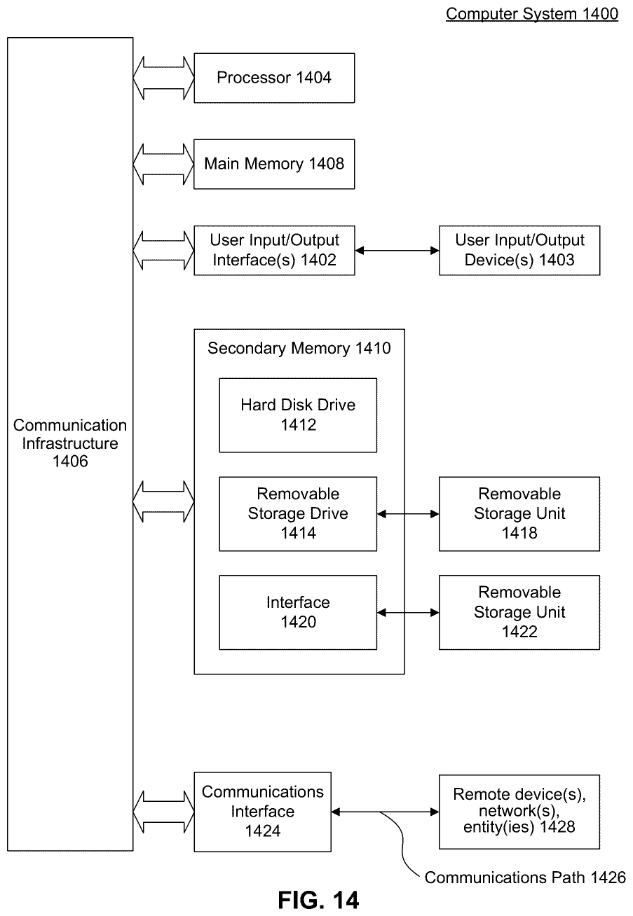

Various aspects can be implemented, for example, using one or more well-known computer systems, such as computer system 1400 shown in FIG. 14. Computer system 1400 can be any well-known computer capable of performing the functions described herein. For example, and without limitation: the AP STA 110, non-AP STA 150 and the non-AP STA 170 of FIG. 1, the wireless device 200 of FIG. 2, the transmitting devices of FIGS. 3A, 3B, 4A, 4B, 5A, 5B, 6-8, 11A, 11B, and 12A-12C, and the receiving devices of FIGS. 3A, 3B, 4A, 4B, 5A, 5B, 6-8 and 11A, 11B, and 12A-12C (and/or other apparatuses and/or components shown in the figures) can be implemented using computer system 1400 or portions thereof.

Computer system 1400 includes one or more processors (also called central processing units, or CPUs), such as a processor 1404. Processor 1404 is connected to a communication infrastructure 1406 that can be a bus. One or more processors 1404 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 1400 also includes user input/output device(s) 1403, such as monitors, keyboards, pointing devices, etc., that communicate with communication infrastructure 1406 through user input/output interface(s) 1402. Computer system 1400 also includes a main or primary memory 1408, such as random access memory (RAM). Main memory 1408 can include one or more levels of cache. Main memory 1408 has stored therein control logic (e.g., computer software) and/or data.

Computer system 1400 can also include one or more secondary storage devices or memory 1410. Secondary memory 1410 can include, for example, a hard disk drive 1412 and/or a removable storage device or drive 1414. Removable storage drive 1414 can be a floppy disk drive, a magnetic tape drive, a compact disk drive, an optical storage device, tape backup device, and/or any other storage device/drive.

Removable storage drive 1414 can interact with a removable storage unit 1418. Removable storage unit 1418 includes a computer usable or readable storage device having stored thereon computer software (control logic) and/or data. Removable storage unit 1418 can be a floppy disk, magnetic tape, compact disk, DVD, optical storage disk, and/any other computer data storage device. Removable storage drive 1414 reads from and/or writes to removable storage unit 1418 in a well-known manner.

According to some aspects, secondary memory 1410 can include other means, instrumentalities or other approaches for allowing computer programs and/or other instructions and/or data to be accessed by computer system 1400. Such means, instrumentalities or other approaches can include, for example, a removable storage unit 1422 and an interface 1420. Examples of the removable storage unit 1422 and the interface 1420 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1400 can further include a communication or network interface 1424. Communication interface 1424 enables computer system 1400 to communicate and interact with any combination of remote devices, remote networks, remote entities, etc. (individually and collectively referenced by reference number 1428). For example, communication interface 1424 can allow computer system 1400 to communicate with remote devices 1428 over communications path 1426, which can be wired and/or wireless, and which can include any combination of LANs, WANs, the Internet, etc. Control logic and/or data can be transmitted to and from computer system 1400 via communication path 1426.

The operations in the preceding aspects can be implemented in a wide variety of configurations and architectures. Therefore, some or all of the operations in the preceding aspects can be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1400, main memory 1408, secondary memory 1410 and removable storage units 1418 and 1422, as well as tangible articles of manufacture embodying any combination of the foregoing. Such control logic, where executed by one or more data processing devices (such as computer system 1400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 14. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more but not all exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects can perform functional blocks, steps, operations, methods, etc. using orderings different from those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, where a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

What is claimed is:

1. A receiving device comprising:
a transceiver; and
a processor communicatively coupled to the transceiver, configured to:
receive, via the transceiver, a multi-user-physical layer (PHY) protocol data unit (MU-PPDU) comprising a preamble and a plurality of data portions, wherein a first data portion of the plurality of data portions is directed to the receiving device and the preamble comprises a PHY multi-user-block acknowledgement request (MU-BAR) frame indicating a frequency band for transmitting a trigger-based (TB)-PPDU;
decode at least a portion of the first data portion; and
transmit, using the transceiver, the TB-PPDU comprising feedback (FB) data corresponding to the first data portion in the indicated frequency band.

2. The receiving device of claim 1, wherein when decoding of the first data portion fails, the TB-PPDU further comprises a negative acknowledgment (NACK) frame and an FB sequence number associated with the MU-PPDU.

3. The receiving device of claim 1, wherein the processor is further configured to: decode a Media Access Control (MAC) Protocol Data Unit (MPDU) of the first data portion, wherein the TB-PPDU further comprises a block acknowledgment (BA) frame corresponding to the decoded MPDU.

4. The receiving device of claim 1, wherein the first data portion does not include an MU-BAR frame.

5. The receiving device of claim 1, wherein the processor is further configured to:
determine that the PHY MU-BAR frame is included in the preamble based at least on a value of a NACK indicator in the preamble and a number of user information fields in the preamble being greater than one.

6. The receiving device of claim 1, wherein the processor is further configured to:
determine that the PHY MU-BAR frame is included in the preamble based at least on a value of a NACK indicator in the preamble and a value of a specific bit status included in the preamble.

7. The receiving device of claim 1, wherein the PHY MU-BAR frame is included in a user-specific field of the preamble and the PHY MU-BAR frame comprises:
information common to the receiving device and a second receiving device, wherein a second data portion of the plurality of data portions corresponds to the second receiving device;
first user information corresponding to the receiving device; and
second user information corresponding to the second receiving device.

8. The receiving device of claim 7, wherein the first data portion comprises a trigger frame, the first user information comprises a subset of the trigger frame, and the first user information indicates an uplink (UL) target receive power.

9. A transmitting device comprising:
a transceiver; and
a processor communicatively coupled to the transceiver, configured to:
transmit, via the transceiver, a multi-user-physical layer protocol data unit (MU-PPDU) comprising a preamble and a plurality of data portions, wherein a first data portion of the plurality of data portions is addressed to a receiving device and the preamble comprises a physical layer (PHY) multi-user-block acknowledgement request (MU-BAR) frame indicating a frequency band for transmitting a trigger-based (TB)-PPDU;
receive, via the transceiver and in the indicated frequency band, the TB-PPDU comprising feedback (FB) data corresponding to the first data portion of the plurality of data portions; and
configure, based at least on the FB data, a transmission parameter for a next data portion associated with the receiving device.

10. The transmitting device of claim 9, wherein a value of a NACK indicator in the preamble and a number of user information fields in the preamble being greater than one indicates that the PHY MU-BAR frame is included in the preamble.

11. The transmitting device of claim 9, wherein a value of a NACK indicator in the preamble and a value of a specific bit status in the preamble indicates that the PHY MU-BAR frame is included in the preamble.

12. The transmitting device of claim 9, wherein the PHY MU-BAR frame is included in a user-specific field of the preamble and comprises:
information common to the receiving device and a second receiving device, wherein a second data portion of the plurality of data portions corresponds to the second receiving device;
first user information corresponding to the receiving device;
and second user information corresponding to the second receiving device.

13. The transmitting device of claim 12, wherein the first data portion comprises a trigger frame, the first user information comprises a subset of the trigger frame, and the first user information comprises an uplink (UL) target receive power.

14. The transmitting device of claim 12, wherein the processor is further configured to:
determine, based at least on a communication history with the receiving device, to include the first user information corresponding to the receiving device in the PHY MU-BAR frame.

15. The transmitting device of claim 14, wherein the communication history with the receiving device indicates that the transmitting device has transmitted at least N MU-BAR trigger frames to the receiving device, where N is an integer, and a TB-PPDU corresponding to at least one of the N MU-BAR trigger frames has not been received within a given time frame.

16. A method of operating a receiving device comprising:
receiving a multi-user-physical layer (PHY) protocol data unit (MU-PPDU) comprising a preamble and a plurality of data portions, wherein a first data portion of the plurality of data portions is directed to the receiving device and the preamble comprises a PHY multi-user-block acknowledgement request (MU-BAR) frame indicating a frequency band for transmitting a trigger-based (TB)-PPDU;
decoding at least a portion of the first data portion; and
transmitting the TB-PPDU comprising feedback (FB) data corresponding to the first data portion in the indicated frequency band.

17. The method of claim 16, wherein when decoding at least a portion of the first data portion fails, the TB-PPDU further comprises a negative acknowledgment (NACK) frame and a FB sequence number associated with the MU-PPDU.

18. The method of claim 16, wherein decoding at least a portion of the first data portion further comprises:
decoding a Media Access Control (MAC) Protocol Data Unit (MPDU) of the first data portion, the TP-PPDU further comprising a block acknowledgment (BA) frame corresponding to the decoded MPDU.

19. The method of claim 16, wherein the method further comprises:
determining that the PHY MU-BAR frame is included in the preamble based at least on a value of a NACK indicator in the preamble and a number of user information fields in the preamble being greater than one.

20. The method of claim 16, wherein the PHY MU-BAR frame is included in a user-specific field of the preamble and comprises:
information common to the receiving device and a second receiving device, wherein a second data portion of the plurality of data portions corresponds to the second receiving device;
first user information corresponding to the receiving device; and
second user information corresponding to the second receiving device.
